(19) United States
(12) Patent Application Publication
(10) Pub. No.: US 2020/0341740 A1
(43) Pub. Date: Oct. 29, 2020

(54) ALIASING ENTITIES IN RECORDED CODE

(71) Applicant: Microsoft Technology Licensing, LLC, Redmond, WA (US)

(72) Inventors: Gergely Kota, Redmond, WA (US); Shahzeb Asif, Redmond, WA (US); Ilia Pavlov, Redmond, WA (US)

(21) Appl. No.: 16/392,092

(22) Filed: Apr. 23, 2019

(51) Int. Cl. G06F 8/41; G06F 8/20; G06F 9/54; G06F 17/22

(52) U.S. Cl. CPC G06F 8/41; G06F 17/2252; G06F 9/542; G06F 8/24

(57) ABSTRACT

Disclosed in some examples are methods, systems, devices, and machine-readable mediums for aliasing entities in recorded code. A method is disclosed that includes receiving, at a recorder application, an indication of an operation from an electronic document application, the indication of the operation indicating a reference to an object and indicating the operation was performed on the object within the electronic document application. The method may further include generating a first line of code, where the first line of code is configured to, when played back by the recorder application, cause a variable to be set to a value of the object; and generating within the recorder application a second line of code that references the object using the variable, where the second line code is configured to, when played back by the recorder application, perform the operation on the object within the electronic document application.

### TECHNICAL FIELD

Some embodiments relate to aliasing entities in recorded code. Some embodiments relate to generating macro code from user actions or operations in a spreadsheet where entities referenced in the spreadsheet are given aliases in the macro code.

### BACKGROUND

Generating code (e.g., macro code) from user actions or operations in an electronic document application (e.g., a spreadsheet) may be beneficial as a user may then not need to perform the user actions or operations again, but rather may execute the generated code. Additionally, it may be important for the user to be able to quickly understand and edit the generated code.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a system for aliasing entities in recorded code, in accordance with some embodiments;

FIG. 2 illustrates a method for aliasing entities in macro recorded code, in accordance with some embodiments;

FIG. 3 illustrates the operation of a method for aliasing entities in macro recorded code, in accordance with some embodiments;

FIG. 4 illustrates generation of a code tree, in accordance with some embodiments;

FIG. 5 illustrates code tree, nodes code, and in order traversal, in accordance with some embodiments;

FIG. 6 illustrates macro code, in accordance with some embodiments;

FIG. 7 illustrates macro code, in accordance with some embodiments;

FIG. 8 illustrates the operation of a method for aliasing entities in macro recorded code where an extra code line is not generated, in accordance with some embodiments;

FIG. 9 illustrates the operation of a method for aliasing entities in macro recorded code where an extra code line is generated, in accordance with some embodiments.

FIG. 10 illustrates the operation of a method for aliasing entities in macro recorded code where extra code lines are generated, in accordance with some embodiments;

FIG. 11 illustrates a method for aliasing entities in recorded code in accordance with some embodiments;

FIG. 12 illustrates a method for aliasing entities in recorded code in accordance with some embodiments;

FIG. 13 illustrates a method of combining recorded actions, in accordance with some embodiments;

FIG. 14 illustrates the operation of a method of combining recorded actions, in accordance with some embodiments;

FIG. 15 illustrates the operation of a method of combining recorded actions, in accordance with some embodiments;

FIG. 16 illustrates the operation of a method of combining recorded actions, in accordance with some embodiments;

FIG. 17 illustrates a method of combining recorded actions, in accordance with some embodiments;

FIG. 18 illustrates a method of combining recorded actions, in accordance with some embodiments;

FIG. 19 illustrates the operation of a method of combining recorded actions, in accordance with some embodiments;

FIG. 20 illustrates a method of combining recorded actions, in accordance with some embodiments;

FIG. 21 illustrates a method for aliasing entities in recorded code in accordance with some embodiments; and

FIG. 22 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims. Disclosed in some examples are methods, systems, devices, and machine-readable mediums for aliasing entities in recorded code. Operations and actions may be used interchangeably. A user may use an electronic document application (e.g., a spreadsheet) that sends actions or operations the user takes within the electronic document application to another application (e.g., a macro recorder) that records the actions of the user. The actions may be actions a user takes using a user interface of the electronic document application. The actions sent to the macro recorder may reference objects within the electronic document application implicitly where the references to the objects are based on a context of the electronic document application. For example, an action may include a reference to a cell of a spreadsheet that implicitly references a worksheet of the spreadsheet. The macro recorder identifies actions where objects are referenced implicitly and generates macro code to generate the object within the electronic document application. The macro code that generates the object assigns an alias within the macro recorder to the object. The macro recorder generates macro code that references the alias for subsequent actions that reference the object either explicitly or implicitly. The macro code that is generated may be easier to read because actions with implicit references to objects within the electronic document application are replaced with macro code with explicit references to aliases.

A technical problem is that macro code generated without aliasing may not run properly unless the macro code is run when the electronic document application has the same context as when the macro code was generated. However, macro code generated with aliasing may run properly since the macro code generates the objects within the electronic document application.

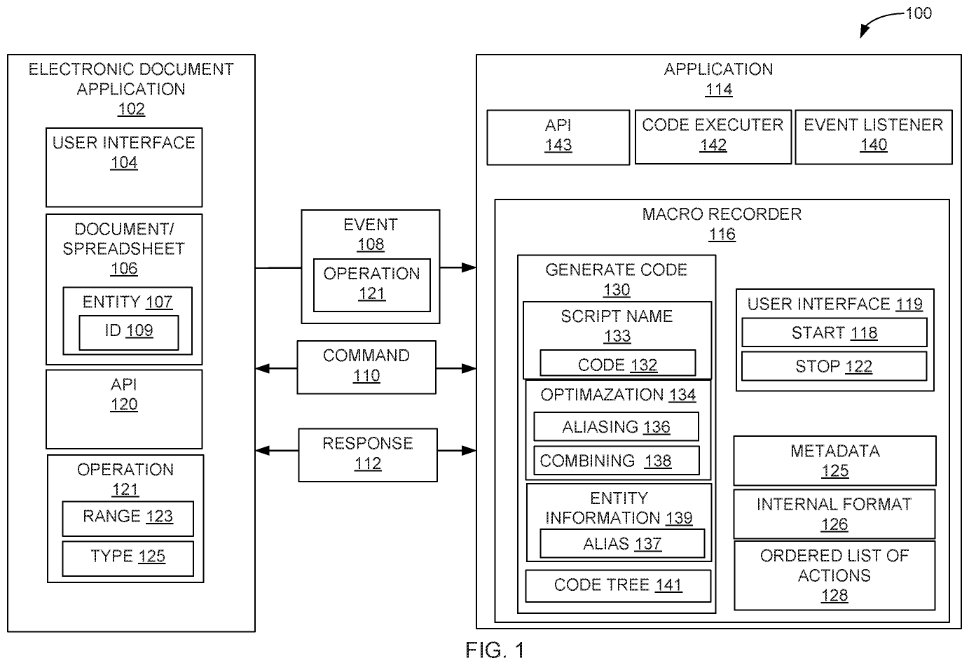

FIG. 1 illustrates a system for aliasing entities in recorded code 100, in accordance with some embodiments. Illustrated in FIG. 1 is electronic document application 102, event 108, command 110, response 112, and application 114. The electronic document application 102 may be a spreadsheet, word processor, presentation program, etc. An example of the electronic document application 102 is EXCEL®. The electronic document application 102 includes a user interface 104, document/spreadsheet 106, API 119, and operations 121. The user interface 104 presents a user interface for a user (not illustrated) to enter instructions or operations 121 to the electronic document application 102. The document/spreadsheet 106 is a document or spreadsheet that the electronic document application 102 is editing or creating. The document/spreadsheet 106 may be another type of object, e.g., a slide. Entity 107 may be a portion of the document/spreadsheet 106, e.g., a cell, a sheet, a table, a selection of cells, etc. An entity 107 may be an object separate from the document/spreadsheet 106, e.g., metadata. An entity 107 may have an identification (id) associated with the entity 107 that identifies the entity 107 and may be used to access the entity 107. Example entities 107 of a spreadsheet include charts, sheets, shapes, etc., in accordance with some embodiments. The electronic document application 102 may send a command 110 to the application 114. For example, the electronic document application 102 may have a user interface 104 selection for start 118, which may be sent to the application 114. The application 114 may send a response 112 to the electronic document application 102 such as recording begun or initialization complete.

The operation 121 are actions within the electronic document application 102, e.g., set a cell of a spreadsheet to a value, format a cell, create a new spreadsheet sheet, get a value of a cell of a spreadsheet, etc. The operations 121 may include a range 123 that indicates the range that the actions should be operated on, e.g., range 123 may indicate one or more cells of a spreadsheet. The operations 121 may include a type 125 that indicates the type of operation 121, e.g., bold, set color, cell value edits, and set background color, etc. Events 108 are broadcast to indicate an operation 121 within the electronic document application 102, e.g., a user may have performed an operation 121. In some embodiments, events 108 includes information about the operation 121, e.g., an identification of a sheet of a spreadsheet, an address of a cell of a sheet, a value that was used to set a cell, a format that was used to set a cell of a sheet, an indication that a new sheet was created, etc. See, for example, order list of actions 128, actions 802, 902, 1002, etc.

The application 114 includes macro recorder 116, event listener 140, code executer 142, and API 143. The application 114 is a macro code recorder/player, in accordance with some embodiments. In some embodiments, the application 114 is a taskpane that uses API 143 to interact with the electronic document application 102 via events 108, commands 110, and responses 112, in accordance with some embodiments. Event listener 140 listens for or receives events 108. Code executer 142 may include API 143. The API 143 may be a Microsoft Office Rich API. The API 143 enables the code executor 142 to execute operations 121 within the electronic document application 102 using the API 119 of the electronic document application 102. The code executer 142 executes the code 132 generated by generate code 130. The code executer 142 may send commands 110 to the electronic document application 102 such as operations 121 to be performed. The electronic document application 102 may send responses 112 to the commands 110 to the code executer 142, e.g., a pointer to a spreadsheet.

Macro recorder 116 includes UI 119, metadata 125, internal format 126, ordered list of actions 128, and generate code 130. The UI 119 presents options for a user (or another program), e.g., start 118, stop 122, generate code, etc. In an example, where the electronic document application 102 is a spreadsheet, the start 118 may send a command 110 to electronic document application 102 to perform the following: fetch names of all sheets, tables, etc.; fetch name of selected sheet; fetch address of selected range, etc. The response 112 to the command 110 may be stored in metadata 125. The metadata 125 may be information regarding a state of the electronic document application 102 before the start (e.g., after start 118 is selected) or at the start of recording operations 121. Internal format 308 is an example of metadata 125 that is retrieved from a spreadsheet.

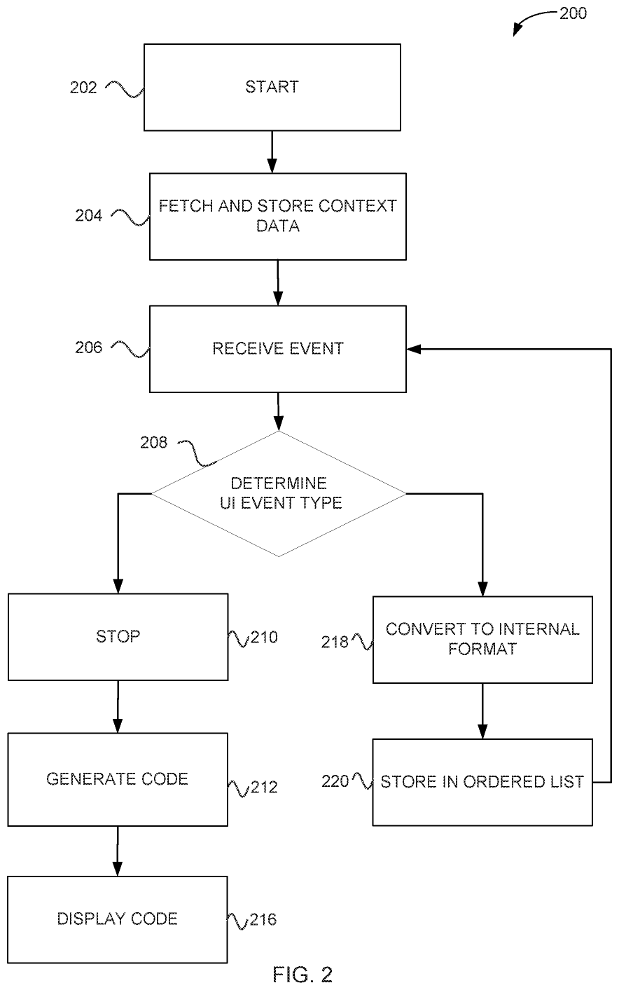

The macro recorder 116 receives events 108 from the event listener 140 and transform the operations 121 of the events 108 into an internal format 126. The internal format 126 is described herein (e.g., FIGS. 2-9) and facilitates the generation of code 132. The macro recorder 116 maintains an ordered list of actions 128 from the events 108. The ordered list of actions 128 is an ordered list of an internal format 126 of the operations 121, in accordance with some embodiments.

Generate code 130 takes the ordered list of actions 128 and generates code 132. The code 132 is readable format that may be displayed by the user interface 119 to a user. The code 132 may have a script name 133 associated with the code 132. The code 132 may be in JavaScript®, VisualBasic®, or another programming language that utilizes the API 143 to access operations 121 and entities 107 within the electronic document application 102. The code 132 replays the ordered list of actions 128. The code 132 may be generated based on the metadata 125 as disclosed herein.

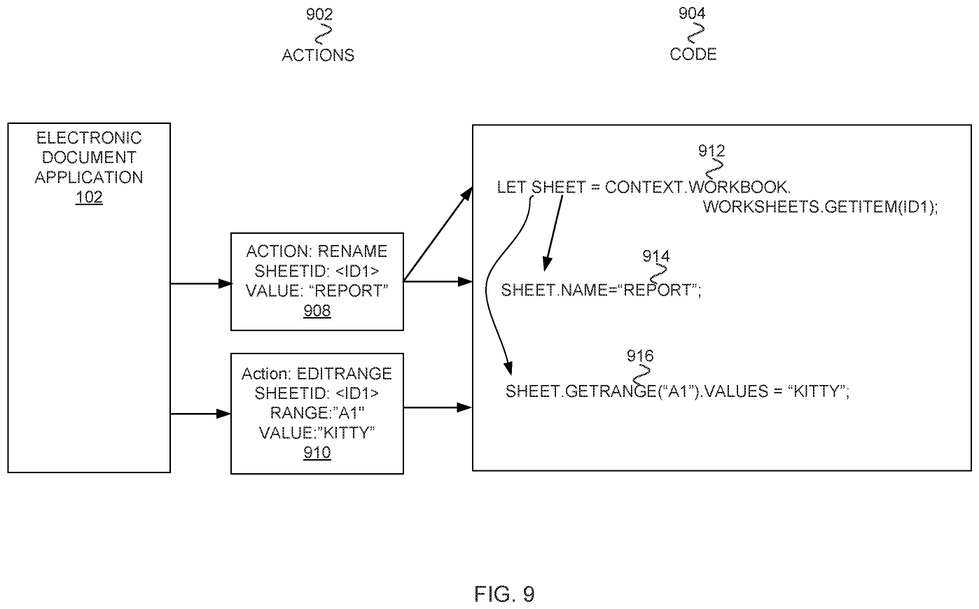

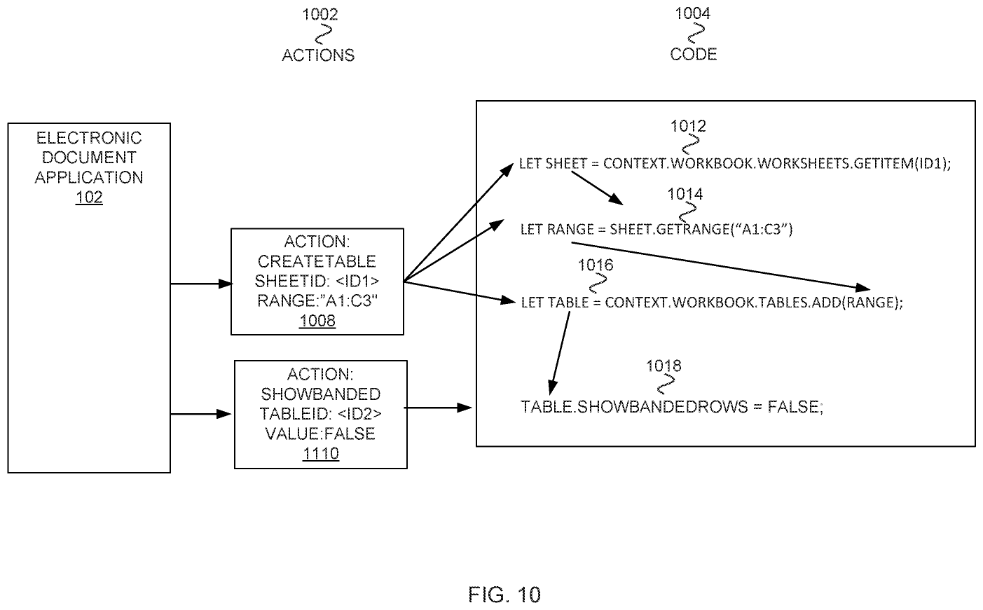

In some embodiments, generate code 130 is configured to add extra code 132 preceding an operation 121 that references an entity 107 with an alias 137. For example, as disclosed in conjunction with FIG. 9 code 912 is added to set alias 137 “sheet” to entity 107 “SheetID: <ID1>”. In some embodiments, generate code 130 generates code 132 to set an alias 137 for operations 121 that create an entity 107. For example, referring to FIG. 10, code 1016 sets alias 137 “table” to a value of the table created by “createtable” of action 1008.

Optimization 134 may perform one or more optimizations of the code 132. For example, optimization 134 may include aliasing 136 and combining 138. The optimization 134 may be performed during the generation of the code 132 by generate code 130. Generate code 130 may generate a code tree 141 as an intermediary step in generating the code 132. In some embodiments, generate code 130 generates a code tree 141 with each node comprising a code snippet with placeholders (e.g., “EntityKeyWrapper[id]”.) Entity 107 information may be stored in entity information 139, which may include names and ids of entities 107. Entity information 139 may be used as part of generating the code 132. Entity information 139 may include alias 137 for an entity 107. The alias 137 may be a name to use in the code 132 to refer to entity 107 in the electronic document application 102. In some embodiments, generate code 130 processes the code tree 141 in an inorder traversal where for each node the following is performed. For each placeholder, if an alias has not yet been generated, create one. Use the entity information 139 for the details if an alias has been created. Replace placeholders with the alias for that placeholder's id. Then all the resulting strings are concatenated together to create the code 132.

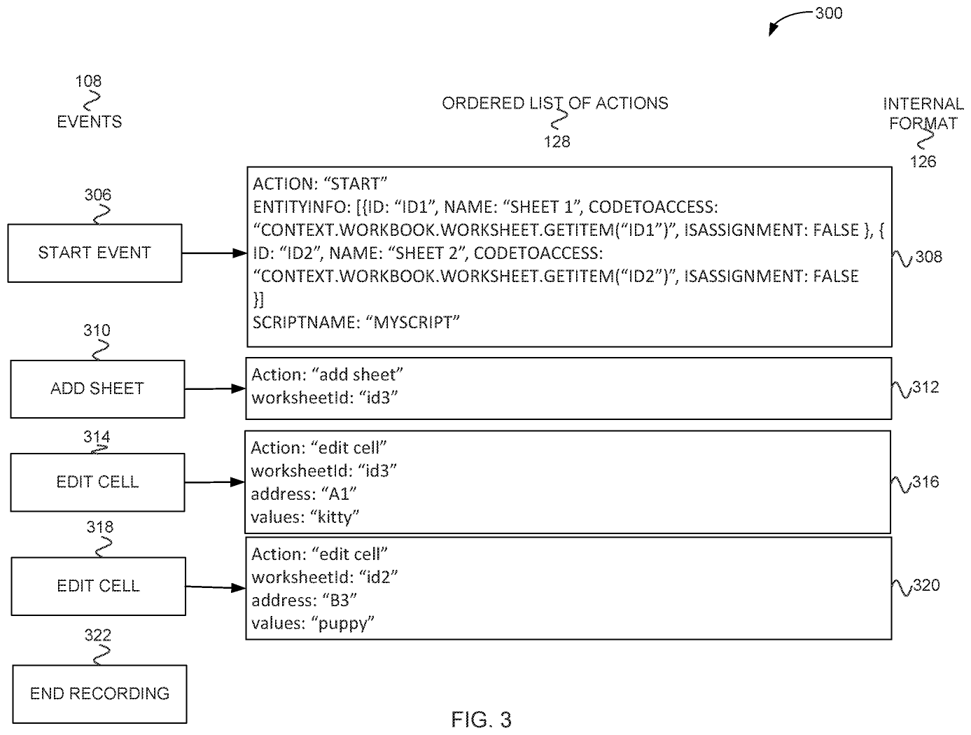

FIG. 2 illustrates a method 200 for aliasing entities in macro recorded code, in accordance with some embodiments. FIG. 2 will be disclosed in conjunction with FIGS. 3-5. The method 200 begins at operation 202 with starting. For example, start 118 may be selected on the user interface 119 (or user interface 104). The application 114 may retrieve metadata 125 from the electronic document application 102 as described in conjunction with FIG. 1. FIG. 3 illustrates the operation of a method 300 for aliasing entities in macro recorded code, in accordance with some embodiments. Illustrated in FIG. 3 is events 108, ordered list of actions 128, and internal format 126. The events 108 may be the same or similar as events 108 of FIG. 1. The ordered list of actions 128 may be the same or similar as ordered list of actions 128 of FIG. 1. The internal format 126 may be the same as similar as internal format 126 of FIG. 1. In another example of operation 202, start event 306 may be received by the application 114, e.g., by event listener 140.

The method 200 continues at operation 204 with fetching and storing context data. For example, the application 114 may retrieve internal format 308 from the electronic document application 102 and store it as metadata 125. The internal format 308 or metadata 125 may include one or more of the following: an indication of the operation 121, “ACTION: ‘START’”; information regarding an entity 107 with ID 109 being “id1” with the following specific information: name: ‘Sheet 1’, code to access: “context.workbook.worksheet.getItem(‘id1’)”, and isAssignment equal to “false”; information regarding another entity 107 with ID 109 being “id2” with the following specific information: name: “Sheet 2”, codeToAccess: “context.workbook.worksheet.getItem(“id2”)”, isAssignment: false; and, with an indication that a script name 133 is “MyScript”. Internal format 308 or metadata 125 indicates that there are two sheets already created “SHEET 1” (“ID1”) and “SHEET 2” (“1D2”).

The method 200 may continue at operation 206 with receiving event. For example, referring to FIG. 3, add sheet 310 may be received. The method 200 may continue at operation 208 with determining UI event type. For example, application 114 may determine that add sheet 310 is not an event 108 of type stop. The method 200 may continue at operation 218 with convert to internal format. For example, the macro recorder 116 may convert add sheet 310 to: “Action: ‘add sheet’ and worksheetid:‘id3’”. The operation 121 is “add sheet’ and the ID 109 of the entity 107 worksheet that is created is “id3”. The method 200 continues at operation 220 with storing in ordered list. For example, internal format 312 may be added to ordered list of actions 128.

The method 200 returns to operation 206 with receiving event. For example, referring to FIG. 3, edit cell 314 may be received. The method 200 may continue at operation 208 with determine UI event type. For example, application 114 may determine that edit cell 314 is not an event 108 of type stop. The method 200 may continue at operation 218 with convert to internal format. For example, the macro recorder 116 may convert edit cell 314 to: “Action: ‘edit cell’; worksheetId: ‘id3’; address: ‘A1’; and values: ‘kitty’”. These indicate that the operation 121 is “edit cell’ and that an ID 109 of the entity 107 worksheet that is edited is “id3”. The method 200 continues at operation 220 with storing in ordered list. For example, internal format 316 may be added to ordered list of actions 128.

The method 200 returns to operation 206 with receiving event. For example, referring to FIG. 3, edit cell 318 may be received. The method 200 may continue at operation 208 with determine UI event type. For example, application 114 may determine that edit cell 318 is not an event 108 of type stop. The method 200 may continue at operation 218 with convert to internal format. For example, the macro recorder 116 may convert edit cell 318 to: “Action: ‘edit cell’; worksheetId: ‘id2’; address: ‘B3’; and values: ‘puppy’”. These indicate that the operation 121 is “edit cell’ and that an ID 109 of the entity 107 worksheet that is edited is “id2”. The method 200 continues at operation 220 with storing in ordered list. For example, internal format 318 may be added to ordered list of actions 128.

The method 200 returns to operation 206 with receiving event. For example, referring to FIG. 3, end recording 322 may be received. The method 200 may continue at operation 208 with determine UI event type. For example, application 114 may determine that end recording 322 is an event 108 of type stop. A user may have selected stop 122 in the user interface 119 (or user interface 104).

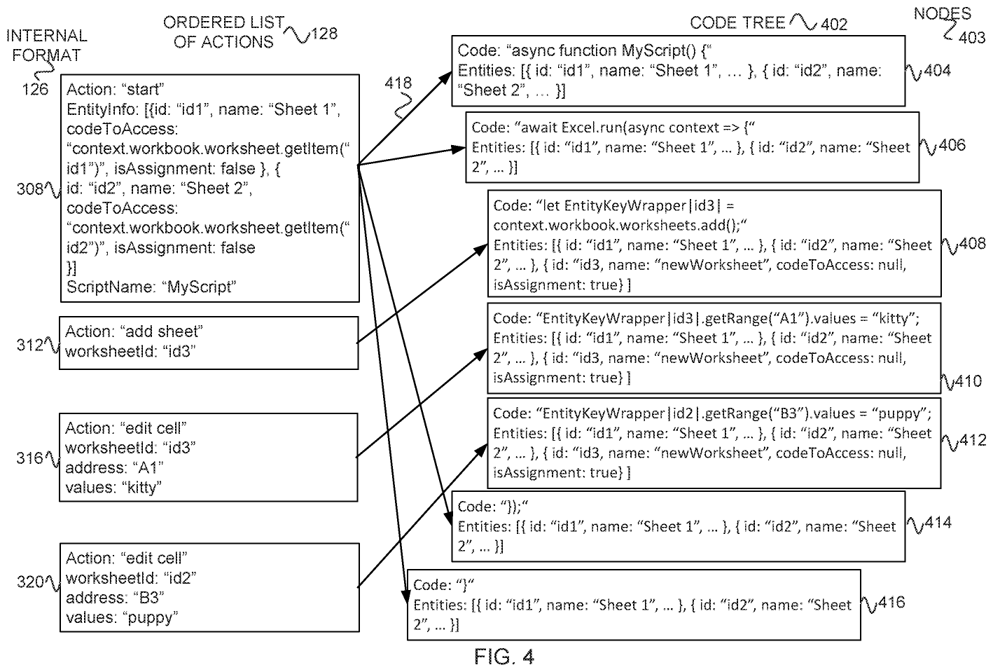

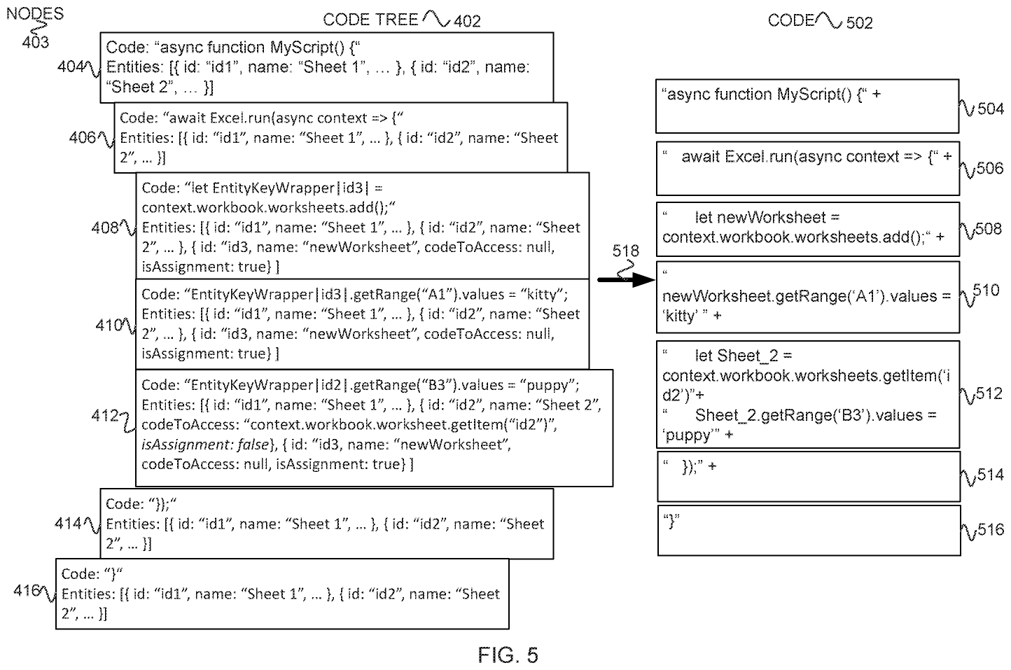

The method 200 may continue at operation 210 with stopping. For example, the macro recorder 116 may stop recording. The method 200 may continue at operation 212 with generating code. For example, FIGS. 4 and 5 illustrate an embodiment of generating code from the ordered list of actions 128.

FIG. 4 illustrates generation of a code tree 402, in accordance with some embodiments. Illustrated in FIG. 4 is ordered list of actions 128, internal format 126, and code tree 402 comprising nodes 403. The nodes 403 are 404, 406, 408, 410, 412, 414, and 416. Generate code 130 generates the code tree 141 (e.g., code tree 402) from the ordered list of actions 128 (e.g., internal format 126). The arrows 418 indicate the nodes 403 that are generated from the internal format 126. For example, generate code 130 generates nodes 404, 406, 414, and 416 from internal format 308. Node 404 names the code and entities. Node 406 waits for the electronic document application 102 (e.g., Excel®) and defines the entities. Node 414 closes the code and defines the entities. Node 416 completes the code close and defines the entities. The code may be determined based on JavaScript® or another programming language. The code is determined based on the API 143 to access the electronic document application 102. For example, “context.workbook.worksheets.add( )” of node 408 is a call to an API 143 routine to add a sheet to a spreadsheet. The API 120 of the electronic document application 102 may provide entry routines for the application 114 to call using the API 143.

Generate code 130 generates node 408 from internal format 312, where node 408 includes code to perform the action of adding a sheet of a spreadsheet. Generate code 130 determines that internal format 312 is adding a sheet (“Action: ‘add sheet’”) that was not created at the start of the script, i.e., it is not part of internal format 308. Generate code 130 determines the code should be “let EntityKeyWrapper[id3]=context.workbook.worksheets.add( ),” where “EntityKeyWrapper[id3]” is place holder for the sheet or alias.

Generate code 130 generates node 410 from internal format 316 where a reference to the sheet created in node 408 is used, i.e., “newWorksheet.” Node 410 includes code to perform the edit cell in accordance with internal format 316. Node 412 includes code to perform edit cell in accordance with internal format 320. Generate code 130 generates node 412 based on the sheet being referenced (“worksheetid:‘id2’”) already existing when the start 118 was selected.

After the code tree 402 is generated, generate code 130 generates code 502. FIG. 5 illustrates code tree 402, nodes 403, code 502, and inorder traversal 518, in accordance with some embodiments. Inorder traversal 518 indicates that generate code 130 traverses the code tree 402 inorder to generate the code 502. An inorder traversal 518 is to traverse a code tree 402 by first visiting nodes 403 in the following order: a left child node, a node, and a right child node, where the procedure is performed recursively. The order of the nodes 403 of the code tree 402 as illustrated in FIG. 5 is of an inorder traversal.

Generate code 130 generates code 504 from node 404, code 506 from 406, code 508 from 408, code 510 from 410, code 512 from node 412, code 514 from node 514, and code 516 from node 416. The alias (e.g., alias 137) “newWorksheet” is created by code 508. The id “id3” may be used within the electronic document application 102 to reference “newWorksheet.” “d3” is used to determine the name to use from node 410, e.g., “newWorksheet.” Code 510 uses the alias “newWorksheet” to edit cell A1 to the value of “kitty.” Code 512 uses the alias “Sheet_2” to edit cell B3 to the value of “puppy.”

Because isAssignment is true in node 403, which indicates a sheet create, generate code 130 does not explicitly generate a line of code to create the alias “newWorksheet.” The alias “newWorksheet” is assigned as a byproduct of the action the user is taking, i.e., code 508.

In node 412 a sheet with id “id2” is being accessed without first an assignment, i.e., “isAssignment: false.” This means the sheet with id “id2” already exists. Generate code 130 first generates a line of code that sets “Sheet_2” to the value of codeToAccess (from node 412), “context.workbook.worksheet. getitem(“id2”). And then generate code 130, generates a line of code to edit cell B3 of “Sheet_2” to the value “puppy”. The code 502 may then be executed to recreate the events 108.

The method 200 may continue with displaying code 216. For example, application 114 or macro recorder 116 may display the code 502 generated as part of a user interface 119. The code executer 142 may execute the code 502, which may produce the same results as events 108. In some embodiments, the code 502 may be saved and used on another spreadsheet of the electronic document application 102.

The method 200 may include one or more additional operations. One or more of the operations of method 200 may be optional. The operations of method 200 may be performed in a different order, in accordance with some embodiments.

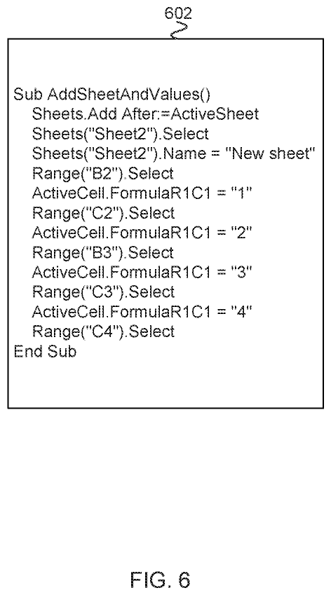

FIG. 6 illustrates macro code 602, in accordance with some embodiments. The macro code 602 may be in Visual Basic®. The macro code 602 does not include aliases. For example, “ActiveCell.FormulaRIC1=‘1’” implicitly is referring to an active sheet, which is “Sheet2”. The macro code 602 may not run properly if it were executed by code executor 142. For example, if macro code 602 were run a second time, then the next “Sheets.Add After:=ActiveSheet” would be set to “Sheet3”. But the next line of macro code would be “Sheets(‘Sheet2’).Select”, so “Sheet2” would be selected. The rest of the actions would be performed on “Sheet2” rather than “Sheet3.” Or if “Sheet2” has been renamed or deleted (or the macro code 602 run in a new spreadsheet), then the macro code 602 would most like not operate properly because “Sheets(‘Sheet2’).Select” would fail.

In some embodiments, the macro code is generated so that when an entity 107 is referenced, then an alias 137 is used to refer to the entity 107. User interface 104 constructs or operations 121 such as select or activate (e.g., operations 121 that set a default or implicit entity 107 such as a sheet) are not used in the macro code, in accordance with some embodiments.

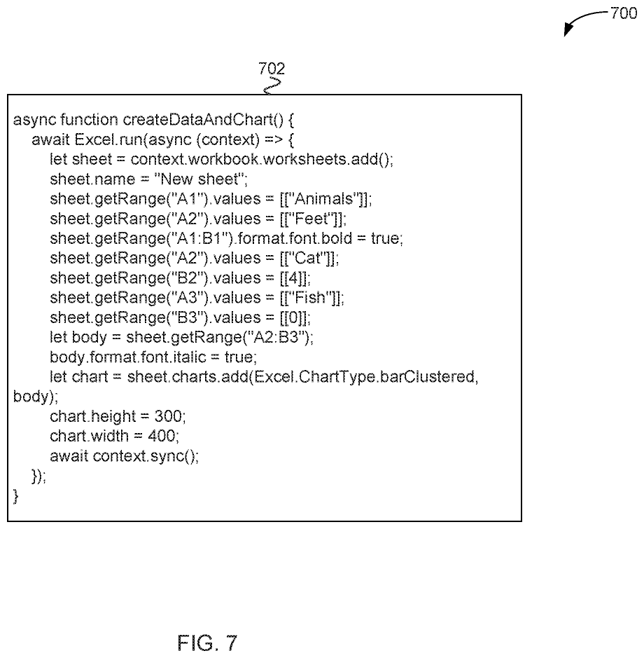

FIG. 7 illustrates macro code 702, in accordance with some embodiments. The macro code 702 may be in Visual Basic. The macro code 702 may be easier for a user to read than the macro code 602 due to the additions of aliases. The alias “sheet” is set to “context.workbook.worksheets.add( )”. This enables the following actions to use the alias “sheet.” Additionally, the alias “body” is set to “sheet.getRange(“A2:B3”)”. This enables the subsequent action to use the alias “body.” Additionally, “chart” is set to “sheet.chart.add (Excel.ChartType.barClustered, body)”. This enables subsequent actions to use the alias “chart.” The use of aliases may make the macro code 702 more portable as easier to understand.

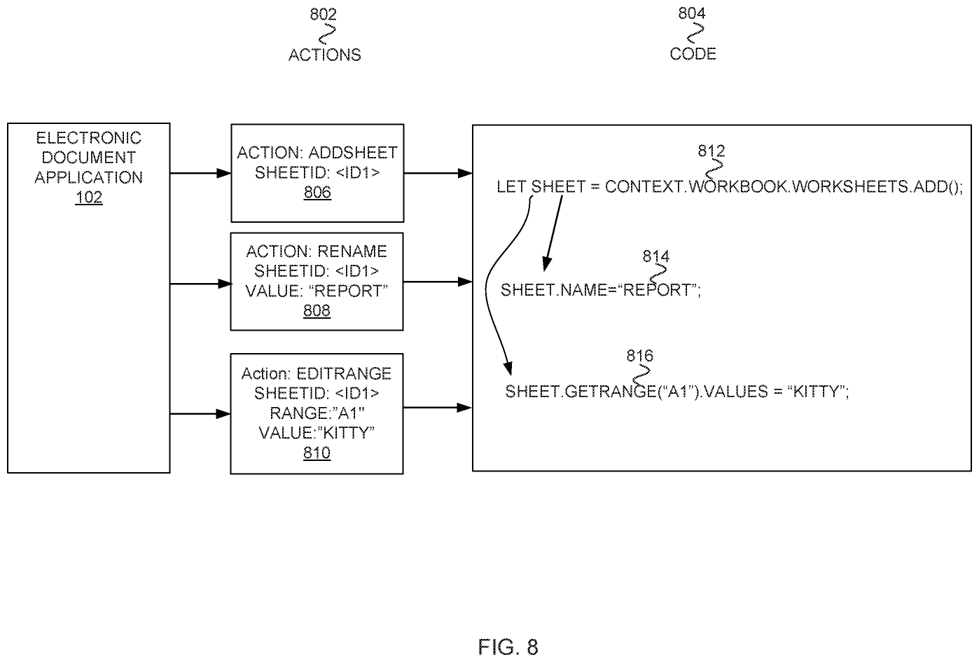

FIG. 8 illustrates the operation of a method for aliasing entities in macro recorded code where an extra code line is not generated, in accordance with some embodiments. Illustrated in FIG. 8 is electronic document application 102, actions 802, and code 804. Electronic document application 102 may be the same or similar as electronic document application 102. Actions 802 may be the same or similar as operations 121. Code 804 may be the same or similar as code 132. The actions 802 may be generated based on (referring to FIG. 1) a user generating events 108 from the use of the user interface 104. In some embodiments the actions 802 have been partially or wholly processed into an internal format 126. The code 804 is code (e.g., Visual Basic®) generated by generate code 130.

Generate code 130 generates an alias “sheet” in code 812 for “addsheet” in action 806. The alias “sheet” enables the other code 814, 816 to use the alias “sheet” rather than using a default or implicit sheet of the electronic document application 102. Generate code 130 can create the alias “sheet” without an extra line because the action 806 is creating the sheet within the electronic document application 102. Generate code 130 generates code 814 from action 808 where rather than using an implicit sheet of electronic document application 102, the alias “sheet” is used explicitly. Generate code 130 generates code 816 from action 810 where the alias “sheet” is used rather than using an implicit sheet of electronic document application 102.

FIG. 9 illustrates the operation of a method for aliasing entities in macro recorded code where an extra code line is generated, in accordance with some embodiments. Illustrated in FIG. 9 is electronic document application 102, actions 902, and code 904. Electronic document application 102 may be the same or similar as electronic document application 102. Actions 902 may be the same or similar as operations 121. Code 904 may be the same or similar as code 132. The actions 902 may be generated based on (referring to FIG. 1) a user generating events 108 from the use of the user interface 104. In some embodiments the actions 902 have been partially or wholly processed into an internal format 126. The code 904 is code (e.g., Visual Basic®) generated by generate code 130. In response to action 908, generate code 130 generates an alias 137 “sheet” in code 912 that “add[s]” a sheet. The alias 137 “sheet” enables the other code 914, 916 to use the alias 137 “sheet” rather than using a default or implicit sheet of the electronic document application 102. Generate code 130 needs an extra line of code 912 because the action 908 is using a sheet “<ID1>” that is already created. Generate code 130 generates code 914 from action 908 where rather than using sheet (“sheeted: <id1>”) of electronic document application 102, the alias 137 “sheet” is used. Generate code 130 generates code 916 from action 910 where the alias 137 “sheet” is used rather than using an implicit sheet of electronic document application 102. The code 904 may be more portable as it creates a “sheet” that is not dependent on a sheet (“sheetID:<ID1>”) already existing within the electronic document application 102. The code 904 may be more readable as the code 912, 914, and 916, explicitly reference the alias 137 “sheet” so that it is clear which sheet is being referenced.

FIG. 10 illustrates the operation of a method for aliasing entities in macro recorded code where extra code lines are generated, in accordance with some embodiments. Illustrated in FIG. 10 is electronic document application 102, actions 1002, and code 1004. Electronic document application 102 may be the same or similar as electronic document application 102. Actions 1002 may be the same or similar as operations 121. Code 1004 may be the same or similar as code 132. The actions 902 may be generated based on (referring to FIG. 1) a user generating events 108 from the use of the user interface 104. In some embodiments the actions 1002 have been partially or wholly processed into an internal format 126. The code 1004 is code (e.g., Visual Basic®) generated by generate code 130. In response to action 1008, generate code 130 generates code 1012, 1014, and 1016. Generate code 130 generates an alias 137 “sheet” in code 1012 that provides an alias 137 “sheet” for “sheeted: <ID1>” of electronic document application 102. Generate code 130 generates code 1014 with an alias 137 “range” for “range:‘A1:C3’ of action 1008. The alias 137 “range” enables “range” to be used in the code 1016. Generate code 130 generates code 1016 with an alias 137 “table” that enables the alias 137 “table” to be used in code 1018.

Generate code 130 generates code 1018 to use the alias 137 “table.” The code 1004 may be more readable as the code 1012, 1014, 1016, and 1018, explicitly reference the aliases “sheet”, “range”, and “table” so that there are not implicit references to entities 107 within electronic document application 102.

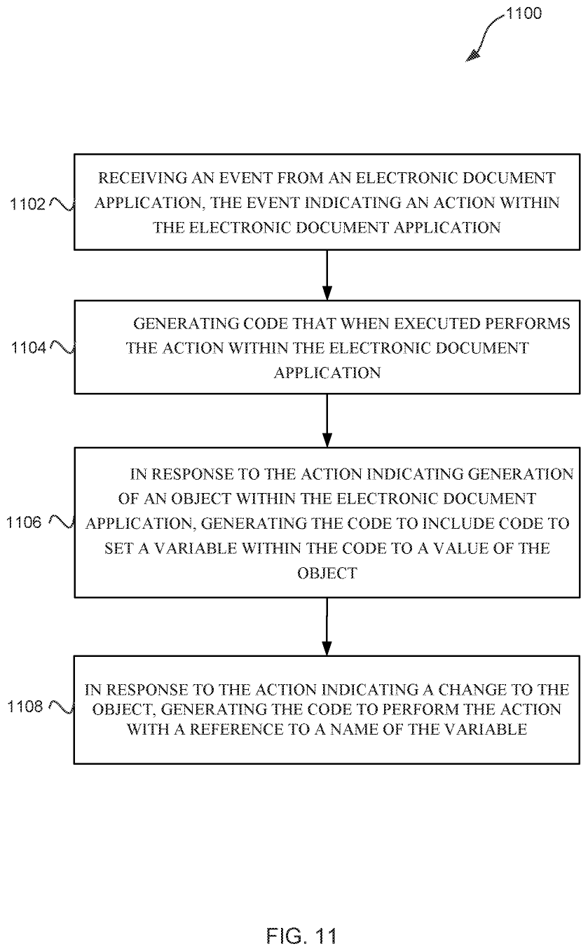

FIG. 11 illustrates a method 1100 for aliasing entities in recorded code, in accordance with some embodiments. Method 1100 begins at operation 1102 with receiving an event from an electronic document application, the event indicating an action within the electronic document application. For example, referring to FIG. 1, application 114 may receive event 108 from electronic document application where the event 108 indicates an operation 121. In another example, referring to FIG. 3, application 114 may receive events 108 with indications of actions within electronic document application 102, e.g., add sheet 310. In another example, referring to FIGS. 8, 9, and 10, application 102 may receive actions 802, 902, 1002, from electronic document application 102. In another example, referring to FIG. 2, method 200 may be performed by application 114 where at operation 206 an event that includes an action is received from electronic document application 102.

The method 1100 continues at operation 1104 with generating code that when executed performs the action within the electronic document application. For example, referring to FIG. 1, generate code 130, generates code 132 that when executed (e.g., code executer 142) performs the operation 121 indicated in the event 108. In another example, operation 212 as disclosed in conjunction with FIG. 2, generates code 132 that when executed (e.g., code executer 142) performs operation 121 within the electronic document application 102. In another example, referring to FIG. 5, generate code 130 generates code 502 from code tree 402. The code 502 performs actions (e.g., “edit cell” 314) within electronic document application 102. In another example, code 702 is an example of code that may be generated by generate code 130 that include code that execute operations 121 within the electronic document application 102, e.g., “sheet.getRange(“B2”).values=[[4]]”. In other examples, code 804, 904, 1004, illustrate code (e.g., 816, 916, 1018) that when executed performs actions within the electronic document application 102.

The method 1100 continues at operation 1106 with in response to the action indicating generation of an object within the electronic document application, generating the code to include code to set a variable within the code to a value of the object. For example, in response to action “add sheet” 310 (FIG. 3) generate code 310 generates code 508 “let newWorksheet=context.workbook.worksheets.add( ).” In another example, referring to FIG. 8, generate code 130 from action 806 “action:addsheet sheeted: <id1>” generates code 812 “let sheet=context.workbook.worksheets.add( ).” Similarly, generate code 130 generates code 1016 from action 1008.

The method 1100 continues at operation 1108 with in response to the action indicating a change to the object, generating the code to perform the action with a reference to a name of the variable. For example, generate code 130 (FIG. 1) generates code 510 (FIG. 5) that references “newWorksheet”. In another example, generate code 130 generates code 814 and 816 (FIG. 8) to reference “sheet.” In another example, generate code 130 generates code 914 and 915 (FIG. 9) to reference “sheet”. In another example, generates code 130 generates code 1014 to reference “sheet,” and generates code 1016 and 1018 to reference “table.”

Method 1100 may be performed on a computing device that includes a processor and memory comprising instructions which when performed by the processor, cause the processor to perform operations of method 1100. Method 1100 may include one or more additional operations. One or more of the operations of method 1100 may be optional. Method 1100 may be performed in a different order.

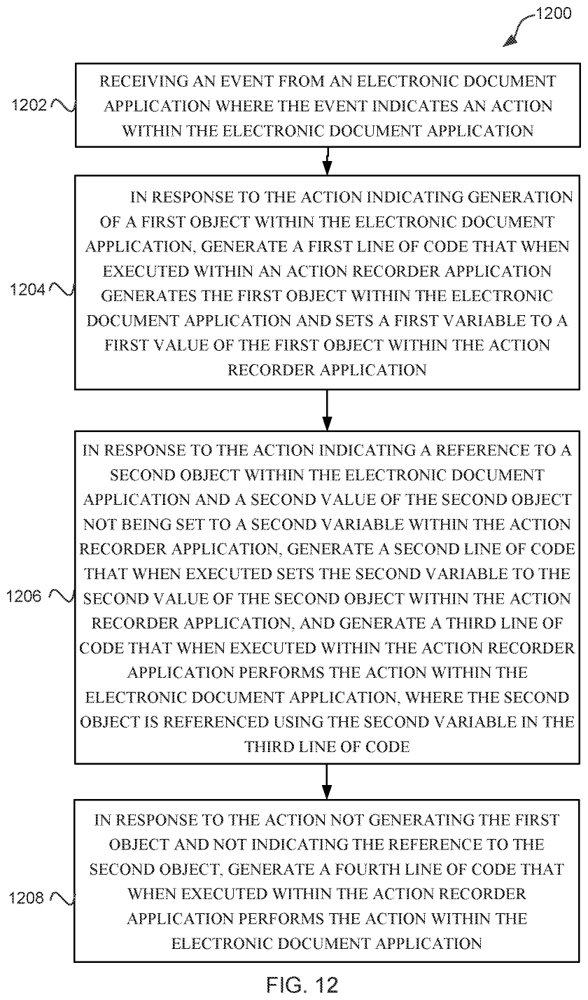

FIG. 12 illustrates a method 1200 for aliasing entities in recorded code, in accordance with some embodiments. Method 1200 begins at operation 1202 with receiving an event from an electronic document application, the event indicating an action within the electronic document application. For example, referring to FIG. 1, application 114 may receive event 108 from electronic document application where the event 108 indicates an operation 121. In another example, referring to FIG. 3, application 114 may receive events 108 with indications of actions within electronic document application 102, e.g., add sheet 310. In another example, referring to FIGS. 8, 9, and 10, application 102 may receive actions 802, 902, 1002, from electronic document application 102. In another example, referring to FIG. 2, method 200 may be performed by application 114 where at operation 206 an event that includes an action is received from electronic document application 102.

Method 1200 begins at operation 1204 with in response to the action indicating generation of a first object within the electronic document application, generating a first line of code that when executed within an action recorder application generates the first object within the electronic document application and sets a first variable to a first value of the first object within the action recorder application. For example, in response to action “add sheet” 310 (FIG. 3) generate code 310 generates code 508 (FIG. 5) “let newWorksheet=context.workbook. worksheets.add( ).” In another example, referring to FIG. 8, generate code 130 in response to action 806 “action:addsheet sheeted: <id 1>” generates code 812 “let sheet=context.workbook.worksheets.add( ).” Similarly, generate code 130 generates code 1016 from action 1008.

The method 1200 may continue at operation 1206 with in response to the action indicating a reference to a second object within the electronic document application and a second value of the second object not being set to a second variable within the action recorder application, generating a second line of code that when executed sets the second variable to the second value of the second object within the action recorder application, and generating a third line of code that when executed within the action recorder application performs the action within the electronic document application, where the second object is referenced using the second variable in the third line of code. For example, generate code 130 (FIG. 1) in response to event “edit cell” 318 where a value of “worksheetid: ‘id2’” is not set to an alias or second variable (e.g., “sheet_2”), generates code 512 (FIG. 5) with (second line of code) “let Sheet2=” and (third line of code) “sheet_2.getRange . . . ”. In another example, generate code 130 (FIG. 1) in response to action 908 where “sheetID: <ID1>” is not set to an alias or second variable (e.g., “sheet”), generates code 912 (second line of code) “let sheet= . . . ” and code 914 (third line of code) “ ”sheet.name . . . ”. In another example, generate code 130 (FIG. 1) in response to action 1008 (FIG. 10) where a value of “sheetID: <id1>” is not set to an alias or second variable (e.g., “sheet”) generates code 1012 (second line of code) “let sheet . . . ” and code 1014 (third line of code) “Let range=sheet.getrange . . . ”.

The method 1200 continues at operation 1208 with in response to the action not generating the first object and not indicating the reference to the second object, generating a fourth line of code that when executed within the action recorder application performs the action within the electronic document application. For example, if operation 1204 and 1206 are not applicable, then operation 1208 is performed if there is action received. For example, generate code 130 (FIG. 1) may generate code 510 (FIG. 5) in response to event 314 where “newworksheet” has already been set to a value in code 508 and event 314 is not generating a new sheet (e.g., object). In another example, generate code 130 (FIG. 1) may generate code 702 that includes code such as “sheet. getRange(‘A1’).values . . . ” where “sheet” has already been set to a value and is not generating a new sheet (e.g., object). In another example, generate code 130 (FIG. 1) may generate code 816 (FIG. 8) from action 810 since “sheet” has already been set to a value and the action 810 is not generating a newssheet.

Method 1200 may be performed on a computing device that includes a processor and memory comprising instructions which when performed by the processor, cause the processor to perform operations of method 1200. Method 1200 may include one or more additional operations. One or more of the operations of method 1200 may be optional. Method 1200 may be performed in a different order.

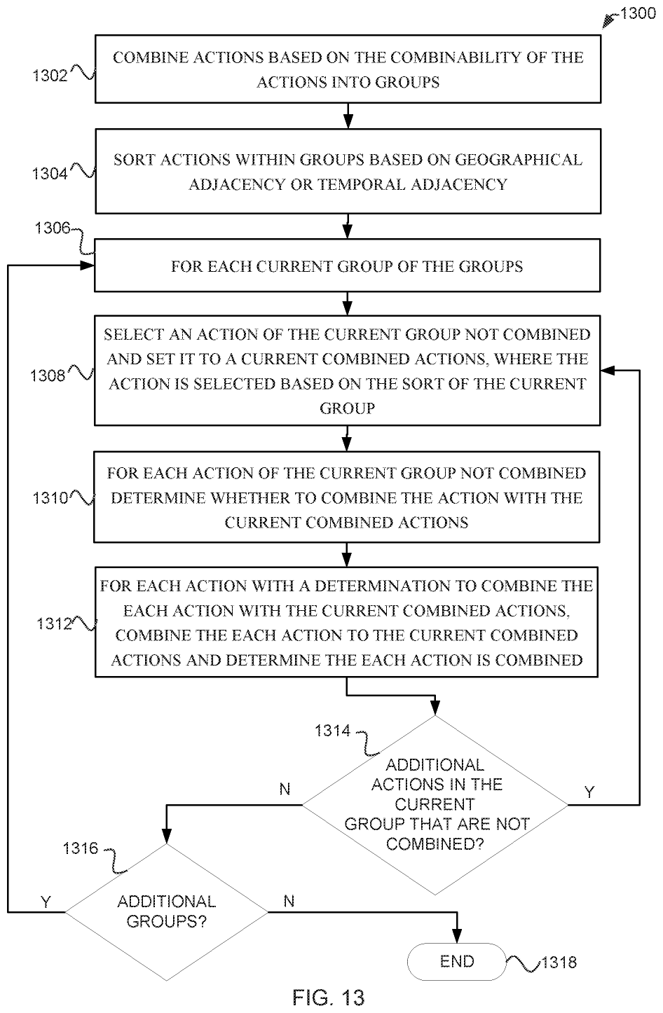

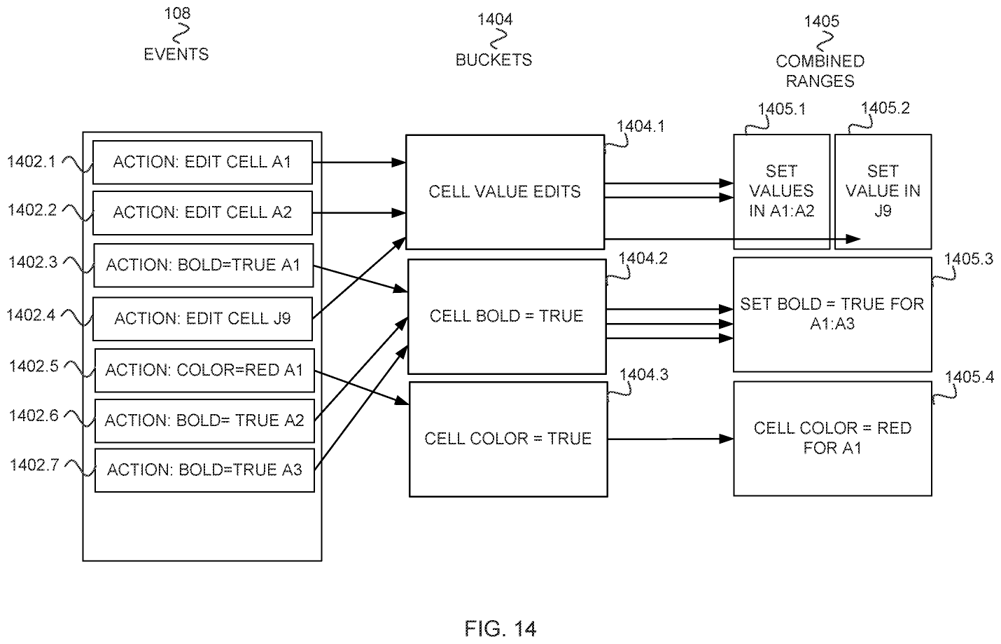

FIGS. 13 and 14 will be disclosed in conjunction with one another. FIG. 13 illustrates a method 1300 of combining recorded actions, in accordance with some embodiments. The method 1300 may be an embodiment of generate code 212 (FIG. 2), in accordance with some embodiments. Referring to FIG. 1, the method 1300 may be an embodiment of combining 138, in accordance with some embodiments. In some embodiments, the method 1300 begins after a stop 122 from the user interface 119. The operations 121 (or 1402 of FIG. 14) may be from a sequence of events 108 received by the application 114 after a start 118 is selected from the user interface 119.

Method 1300 begins at operation 1302 with combining actions based on the combinability of the actions into groups. For example, FIG. 14 illustrates an example of operation 1302. FIG. 14 illustrates the operation of a method of combining recorded actions, in accordance with some embodiments. Illustrated in FIG. 14 is events 108, actions 1402, buckets 1404, and combined ranges 1405. Events 108 may be the same or similar as events 108 of FIG. 1. Actions 1402 may be the same or similar as operations 121 of FIG. 1. Buckets 1404 may be combined actions 1402. Combined ranges 1405 may be ranges that have been combined based on the actions 1402 that have been combined together.

Buckets 1404 may be an example of recorded actions (e.g., actions 1402) being combined based on the combinability of the actions (e.g., actions 1402) into groups (e.g., buckets 1404). The buckets 1404 may be determined based on the type 125 (FIG. 1) of action 1402, e.g., bucket 1404.1 is of type 125 “cell value edits.” The buckets 1404 may also be determined based on other factors, e.g., if there is an interruption action 1402, then actions 1402 may be placed in separate buckets 1404 even if the actions 1402 are a same type 125. Interruptions actions 1402 may include creation of a chart, creation of a table, creation of sheet, etc.

The combinability may be based on whether the actions 1402 can have combined ranges (e.g., range 123 of FIG. 1) within the electronic document application 102. For example, the combinability may be based on whether the ranges can be combined in a range 123 of the operation 121. The combinability may depend on how many cells of a spreadsheet that are included in the range 123 are null or not actions 1402 of a same type 125. For example, there may be cells that the actions 1402 are not performed on or there may be intervening actions 1402 with a different type 125.

The combinability of actions 1402 may depend on more than just a type of the operation 121, e.g., for the operation 121 “bold”, only actions that are setting the “bold” to “true” may be combinable, in accordance with some embodiments. A bucket 1404 is generated for each of the different types of actions 1402 that are combinable, e.g., as illustrated “edit”, “bold”, and “color”. As illustrated actions 1402.1, 1402.2, and action 1402.4 are combined into bucket “cell value edits” 1404.1; actions 1402.3, 1402.6, and 1402.7 are combined into bucket “cell bold=true” 1404.2; and, action 1402.5 is combined into bucket “cell color=true” 1404.3.

The method 1300 may continue at operation 1304 with sorting actions within groups based on geographical adjacency or temporal adjacency. For example, action 1402.1, 1402.2, and 1402.4 may be sorted within bucket 1404.1 based on geographic adjacency (e.g., based on the cell locations within a spreadsheet) so that action 1402.1 is first as it references cell A1, action 1402.2 may be second as it references cell A2, and action 1402.4 may be last as it references cell J9. Similarly bucket 1404.2 may be sorted based on geographic adjacency. Bucket 1404.3 only has one entry. In some embodiments, the actions 1402 may be sorted based on temporal adjacency. In some embodiments, the actions 1402 may be sorted based on temporal adjacency as well as geographic adjacency. For example, if action 1402.2 was performed after action 1402.4 and there were several actions 1402 between the performance of action 1402.2 and 1402.4, then action 1402.4 may be in a sort order before action 1402.2. In some embodiments, a new bucket 1404 may be created after a threshold number of actions 1402 so that actions 1402 that are not temporally adjacent are not combined. In some embodiments, a new bucket 1404.1 may be created if an action is performed that separates the actions 1402, e.g., an interruption action may separate the actions.

In some embodiments, the buckets 1404 may be determined based on user expectation, e.g., only one bucket 1404 for combinable actions 1402 performed in a sequence, e.g., cell edits or cell formats. In some embodiments, actions 1402 may be determined not to be combinable based on actions 1402 that are performed between the actions 1402. For example, if one or more predefined actions 1402 are performed between actions 1402 that would be combinable otherwise, they may be determined not to be combinable. For example, actions 1402.1 and 1402.2 are combinable as illustrated, but if they were separated by a predetermined action, e.g., interruption action, they may be determined not to be combinable. The predetermined action or interruption action may include creation of a chart, table, or sheet, or an entity edit such as chart formatting or sheet renaming. If actions 1402 that would be combinable if they were next to one another are determined to be not combinable based on actions 1402 that are intervening actions, then an additional bucket 1404 may be created with one bucket 1404 for the actions before the predetermined action and one for the actions 1402 after the predetermined action.

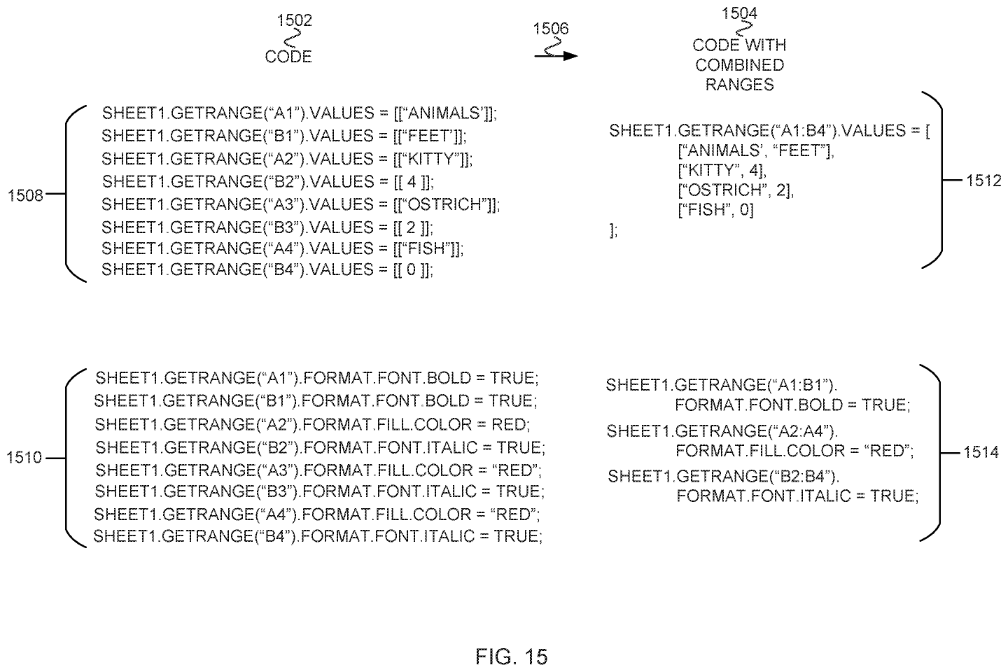

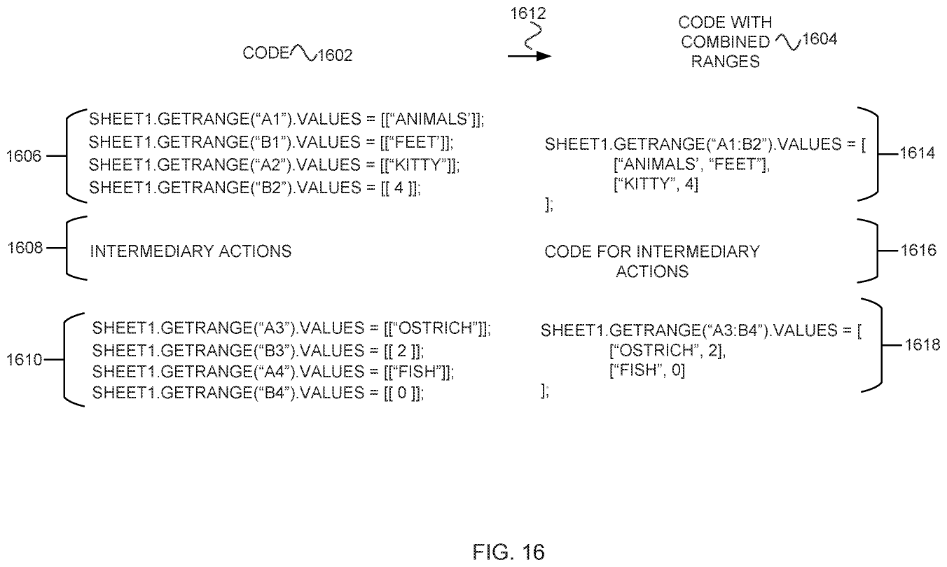

FIGS. 15 and 16 are disclosed in conjunction with FIGS. 13 and 14. FIG. 15 illustrates the operation of a method of combining recorded actions, in accordance with some embodiments. Illustrated in FIG. 15 is code 1502, 1508, 1510, combining recorded actions 1506, and code with combined ranges 1504, 1512, and 1514. The code 1502 is processed by combining recorded actions 1506 (e.g., 1300, 1600, 1700, 2000) that combines recorded operations 121 to generate code with combined ranges 1504. The code 1502 may be code 132 (FIG. 1). In some embodiments, the code 1502 is generated from operations 121 of events 108, and then it is optimized (e.g., combining 138). In some embodiments, combining recorded actions 1506 works an internal format (e.g., 126) before code 1502 (or code 132) is generated.

Code 1508 has operations 121 that are all combinable (e.g., the range 123 is combinable and the operations 121 are all the same type of assigning a cell a value.) Code 1510 is not all combinable. The code 1510 that includes formatting for “format.font.bold” is combinable (e.g., range 123 is combinable to “A1:B1” and the operations 121 are all of the same type) and would get a separate bucket 1404. The code 1510 for “format.fill.color” is combinable (e.g., range 123 is combinable to “A2:A4” and the operations 121 are all of the same type) and would get a separate bucket 1404. The code 1510 for “format.font.italic” is combinable (e.g., range 123 is combinable to “B2:B4” and the operations 121 are all of the same type) and would get a separate bucket 1404.

FIG. 16 illustrates the operation of a method of combining recorded actions, in accordance with some embodiments. Illustrated in FIG. 16 is code 1602, 1606, 1608, 1610, combine recorded actions 1612, and code with combined ranges 1604, 1614, 1616, and 1618. The code 1602 is processed by combine recorded actions 1612 (e.g., 1300, 1600, 1700, 2000) that combines recorded actions 1612 to generate code with combined ranges 1604.

Code 1606 and 1610 would be combinable into a range “A1:B4” with the operations 121 all being the same. However, due to intermediary actions of code 1608, the method (e.g., 1400 or another disclosed herein) determines not to combine code 1606 and code 1610, and instead generates code with combined ranges 1614, 1618. The code 1606 that includes “values” is combinable (e.g., range 123 is combinable to “A1:B2” and the operations 121 are all of the same type) and would get a separate bucket 1404, in accordance with some embodiments. The code 1610 that includes “values” is combinable (e.g., range 123 is combinable to “A3:B4” and the operations 121 are all of the same type) and would get a separate bucket 1404, in accordance with some embodiments. In some embodiments, operation 1304 of method 1300 may generate a new bucket 1404 when the intermediary actions 1608 are processed.

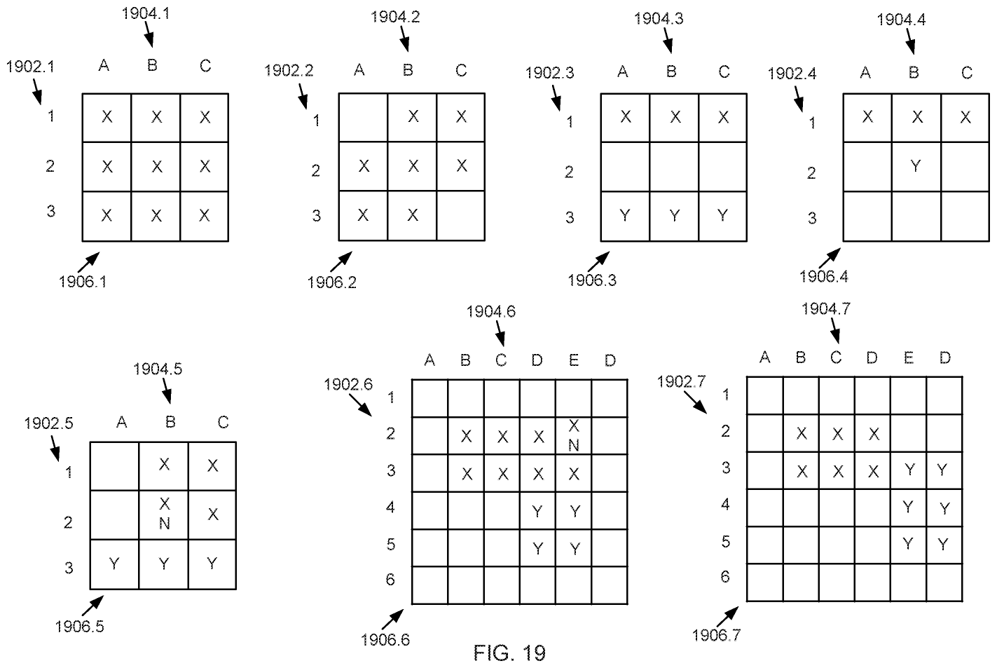

Method 1300 may continue at operation 1306 with for each current group of the groups. For example, referring to FIG. 14, the method 1300 may continue for each of the buckets 1404. Method 1300 may continue with selecting an action of the current group not combined and set it to a current combined actions (there may be only one action in current combined actions), where the action is selected based on the sort of the current group. For example, bucket 1404.1 includes actions 1402.1, 1402.2, and 1402.4, where the actions 1402 would be sorted in that order. Action 1402.1 would be the action selected from the current group (bucket 1404.1). The sort may be based on the cells of a spreadsheet (e.g., FIG. 19 with a column of numbers 1902 and a row of letters 1904).

Method 1300 may continue at operation 1310 for each action of the current group not combined, determine whether to combine the action with the current combined actions. For example, referring to FIG. 14, action 1402.1 may be the current combined actions. Generate code 130 may determine whether actions 1402.2 and 1402.4 should be combined with action 1402.1. Generate code 130 may determine to combine 1402.2, but not 1402.4 since the address “J9” may not be determined to be combinable with “A1” and “A2”. For example, if “J9” were combined with “A1” and “A2” then there would be too many cells that do not have an action 1402 associated with the cell, or there may be other actions 1402 that are references the cells not referenced by an action 1402. FIG. 19 provides examples of combining cells of a spreadsheet.

Method 1300 may continue at operation 1312 with, for each action with a determination to combine the each action with the current combined actions, combine the each action to the current combined actions and determine the each action is combined. For example, referring to FIG. 14, action 1402.2 may be combined with action 1402.1 to generate combined ranges 1405.1, i.e., “set values in A1:A2” where “A1:A2” may be the range 123. Action 1402.2 may be determined to be combined.

Method 1300 continues at operation 1314 with additional actions in the current group that are not combined. For example, referring to FIG. 14, action 1402.4 is not combined and it was in the current group. The method 1300 would return to operation 1308 where action 1402.4 is selected to the current combined actions. Method 1300 continues at operation 1310 where nothing is done since there are no more actions 1402 in the current group. Method 1300 continues at operation 1312 where generate code 130 may generate combined ranges 1405.2, “set value in J9” where “J9” is range 123.

Method 1300 continues at operation 1314 with additional actions in the current group that are not combined. Continuing with the example above, there are no more actions 1402 as actions 1402.1 and 1402.2 were combined into combined ranges 1405.1 and action 1402.4 was combined with no other action into combined ranges 1405.2. Method 1300 continues at “N” to operation 1316 with additional groups. Continuing the example of FIG. 14, there are more groups.

The method 1300 continues at “Y” to operation 1306 with for each current group of the groups. Continuing with the example above, the current group would be bucket 1404.2.

The method 1300 continues at operation 1308. Continuing with the example above, the action selected would be 1402.3 as is not combined and would be the first by a sort of the geography of a spreadsheet.

Method 1300 would continue at operation 1310. Continuing the example above, generate code 130 would determine to combine actions 1402.6 and 1402.7 as both have ranges 123 that are combinable with action 1402.3.

Method 1300 continues at operation 1312. Continuing the example above, generate code 130 would generate combined ranges 1405.3 with “set bold=true for A1:A3” where “A1:A3” is the range 123.

Method 1300 continues at operation 1314. Continuing the example above, there are no additional actions in the current group (bucket 1404.2).

Method 1300 continues at “N” to operation 1316 additional groups. Continuing the example above, there is one more group. Method 1300 continues to operation 1306 where the each current group is set to bucket 1404.3.

Method 1300 continues to operation 1308. Continuing the example above, there is only one action 1402.5 in bucket 1404.3 (current group).

Method 1300 continues at operation 1310. Continuing the example above, there are no more actions in bucket 1404.3 (current group).

Method 1300 continues at operation 1312. Combined ranges 1403 is generated with “cell color=red for A 1” where “A1” is the range 123. Continuing the example above, there are no actions that were determined to be combined.

Method 1300 continues to operation 1314. Continuing the example above, there are no additional action 1402 in bucket 1404.2. The method 1300 continues to operation 1316. Continuing the example above, there is an additional bucket 1403.3 (additional group). The method 1300 continues to operation 1306 and then to operation 1308. Continuing the example above, action 1402.5 is selected as it is the only action 1402 in the bucket 1404.3 (group). The method 1300 continues to operation 1310, 1312. Continuing the example above, generate code 130 generates combined ranges 1405.4 with “cell color=red for A1”.

Method 1300 continues to operation 1314 and follows “N” since there are no additional actions in bucket 1404.3. Method 1300 continues to operation 1316 and follows “N” since there are no additional buckets 1404 after bucket 1404.3. Method 1300 may continue to end 1318.

Method 1300 may be performed on a computing device that includes a processor and memory comprising instructions which when performed by the processor, cause the processor to perform operations of method 1300. Method 1300 may include one or more additional operations. One or more of the operations of method 1300 may be optional. Method 1300 may be performed in a different order.

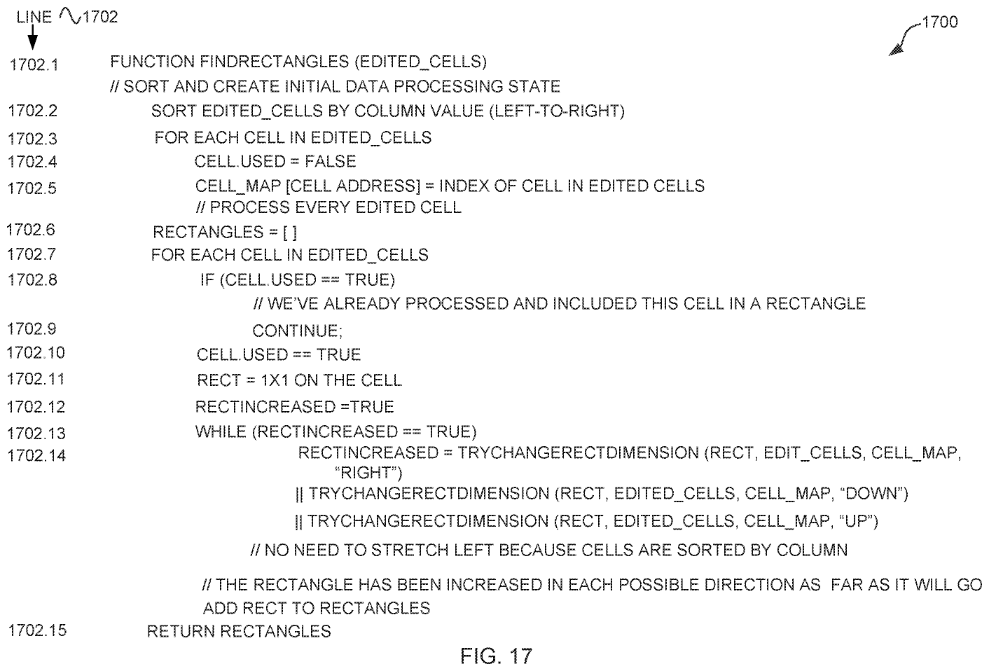

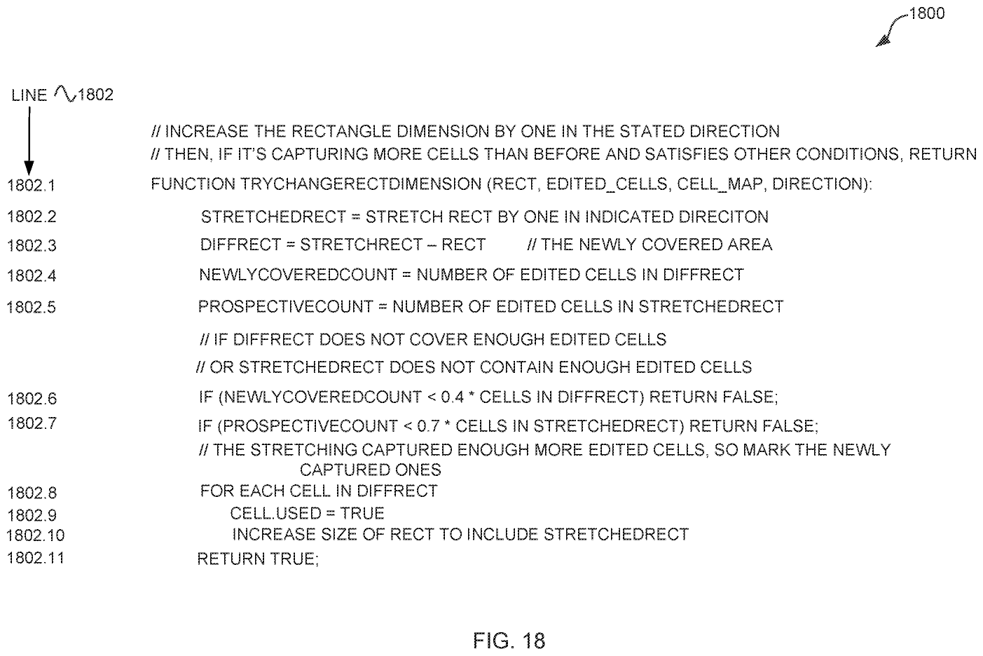

FIGS. 17-19 will be disclosed in conjunction with one another. FIG. 17 illustrates a method 1700 of combining recorded actions, in accordance with some embodiments. Illustrated in FIG. 17 is lines 1702. FIG. 18 illustrates a method 1800 of combining recorded actions, in accordance with some embodiments. Illustrated in FIG. 18 is lines 1802. FIG. 19 illustrates the operation of a method of combining recorded actions, in accordance with some embodiments.

Illustrated in FIG. 19 are cells 1906.1, 1906.2, 1906.3, 1906.4, 1906.5, 1906.6, and 1906.7. The cells 1906 are cells in a spreadsheet. Rows 1902 are along a vertical axis and columns 1904 are along a horizontal axis. The cells 1906 indicate which cells have operations 121 that are combinable. For example, in cells 1906.1, a letter (X in this case) at row 2 and column B indicates there is an operation 121 that has been combined with other operations 121 indicated in cells 1906.1 with an X. Referring to FIG. 15, the six lines of code 1508 that includes “A1”, “B”, “A2”, “B2”, “A”, and “B3” would be represented by cells 1906.1 (note, though that code 1508 does not include the column 1904 C). The Xs of cells 1906.1 indicate that all the cells were combined into a range 123. Similarly, the Ys of cells 1906.6 indicate that all the cells were combined into a range 123. A letter and “N” indicates that the corresponding cell has been joined in a range even though there is no operation 121 associated with the cell. For example, E2 of cells 1906.2 is “X N”, which indicates E2 is combined into a range 123 with B2, C2, D2, B3, C3, D3, and E3, but that there is no operation 121 associated with E2. In some embodiments, the cells 1906.1, 1906.2, 1906.3, 1906.4, 1906.5, 1906.6, and 1906.7 are the same or similar as buckets 1404.

In some embodiments, the method 1700 of FIG. 17 is the same or similar as methods 1300 or 2000. In some embodiments, the method 1800 of FIG. 18 is the same or similar as method 1300 or 2000. The methods 1700 and 1800 are in JScript®, in accordance with some embodiments. The methods 1700 and 1800 are in pseudo-code, in accordance with some embodiments. The method 1700 begins at line 1702.1 with a function definition where a parameter “edited_cells” are the cells of a spreadsheet to perform the method 1700 on. For example, “edited_cells” may be actions 1402 where “edited_cells” includes an operation 121 and range 123 the operation 121 is performed on. The “edited_cells” may already be sorted into operations 121 that are combinable, e.g., edit cells, format cells, etc. The “edited_cells” may be the same or similar as buckets 1404.

The method 1700 continues with line 1702.2 that sorts “edited_cells” by column value, e.g., referring to FIG. 19, an operation 121 that references cell A1 would be before an action that references cell B1. In some embodiments, the sort may be based on a different value than the column value, e.g., row value.

The method 1700 continues at lines 1702.3, 1702.4, and 1702.5 where each “cell” in “edited_cells” has a “used” value associated with it that indicates “false”, which may be the same or similar as “combined” as disclosed in conjunction with the method 1300. Line 1702.5 initializes “cell_map” for each “cell”, which may be used to map between an index of a “cell” in “edited_cells” and a “cell address.” The “cell_map” may be the same or similar as cells 1906.

The method 1700 continues at line 1702.6 where “rectangles” is initialized. The method 1700 continues at lines 1702.7 through 1702.14 with a loop for each “cell” in “edited_cells”. For example, the loop may be performed for each cell that has an “X” or “Y” in FIG. 19. In another example, the loop may be performed for each action 1402 of events 108. Lines 1702.8 and 1702.9 test to see if the “cell” is used and move to the next “cell” if the cell has been used. Lines 1702.7 through 1702.14 are an embodiment of operation 1310, in accordance with some embodiments.

Line 1702.10 sets “cell” used to true so that a “cell” is only examined once. Line 1702.11 initializes a “rect” to a smallest size. Lines 1702.12 through 1702.14 attempt to grow the smallest size “rect.” The “rect” is attempted to be grown “right”, “down”, and “up”. Left is not needed because the “cells” are sorted according to columns, e.g., 1904.

When a “rect” has been grown as much as it can be (based on the thresholds of method 1800), then the “while” of line 1702.13 ends as “rectincreased” is “false”, and the method 1700 moves to line 1702.7 where a next “cell” with “used” equal to “false.” The method 1700 ends at line 1702.5 when all the “cells” have a “used” equal to “true.”

The method 1800 tries to increase the size of the rectangle that is passed to it at line 1802.1, “rect”. At line 1802.2 the “rect” is stretched by one in “direction.” For example, referring to FIG. 19, A1 at cells 1906.1 may be stretched to the right, which would include B1. The A1 at cells 1906.1 may not be stretched up. The A1 at cells 1906.1 may be stretched down to include A2.

Method 1800 at line 1802.3 determines the “diffrect”, which is any new cells added to the “rect”. At line 1802.4 “newlycoveredcount” is the number of cells in “diffract”. At line 1802.5 “prospectivecount” is the number of cells in “stretchedrect.” Lines 1802.6 and 1802.7 determine whether the “stretchedrect” covers enough edited cells. Line 1802.6 determines whether “newlycoveredcount” is less than 0.4 times “cells in diffract”. In some embodiments, a different threshold may be used other than 0.4, e.g., a threshold chosen within the range of 0.2 through 0.9. Line 1802.7 determines whether “prospectivecount” is less than 0.7 times “cells in stretchedrect”. In some embodiments, a different threshold may be used other than 0.7, e.g., a threshold chosen within the range of 0.2 through 0.9. Lines 1802.8 through 1802.11 are performed if there is a determination to stretch the “rect”. Cells “used” is marked as “true” and “rect” is increased to include “stretchedrect.”

The following are examples of methods 1700 and 1800 being performed on cells of a spreadsheet. Referring to FIG. 19, at cells 1906.5, if the current “rect” is B1 and C1 with a direction of “down”, then “stretchedrect” is B1, C1, B2, and C2; the “diffrect” would be B2 and C2; “newlycoveredcout” would be 1 (i.e., B2); and “prospectivecourt” would be 3, i.e., B1, C1, and C2. At line 1802.6, the test would be “if 1<0.4*2”, which is false. At line 1802.7, the test would be 3<0.7*4 (cells in stretchedrect), which is false. The method 1700 would continue to line 1802.8 where “used” for each “cell” in “diffract” is set to “true”, and “rect” is increased to include “stretcheddirect.” Continuing with the example above, “rect” would be set to B1, C1, B2, and C2 of 1906.5. B2 does not have an operation 121 associated with it so it is not an edited cell. Method 1700 would return “true” to method 1800, which would call method 1700 again to try to expand the “rect” with “down.”

In some embodiments, the value of 0.5 (plus delta or “<” changed to “<=”) may be used as a threshold in line 1802 so that the rectangle is not expanded to include one empty cell and one edited cell (e.g., as in the example above with cells 1906.5 with “rect” B1 and C1 being expanded to B1, C1, B2, and C2 when C2 is an edited cell, but B2 is not an edited cell.

In some embodiments, methods 1700 and 1800 may determine to readjust “rect”. For example, referring to cells 1906.4, “rect” may be A1 to start, and then B1 may be added with “right”, then A2 and B2 may be added with “down.” Then C1 and C2 would be attempted to be added with “right”. But “rect” A1, B1, C1, A2, B2, and C2 may fail the test at line 1802.7, since “prospectivecount” (4) is less than 0.7 times “cells in stretchedrect” (6), i.e., 4<4.2. This would mean that C1 would not be added. C1 would then be a second rectangle. However, method 1700 or method 1800 (or another method) may determine to readjust the “rectangles”. For example, methods 1700 and 1800 may determine rectangle A1, B1, A2, B2, should be readjusted because of the empty space at A2 or C2. The rectangles may then be readjusted (as illustrated at 1906.4) to “X” rectangle of A1, B1, and C1, and the rectangle “Y” of B2.

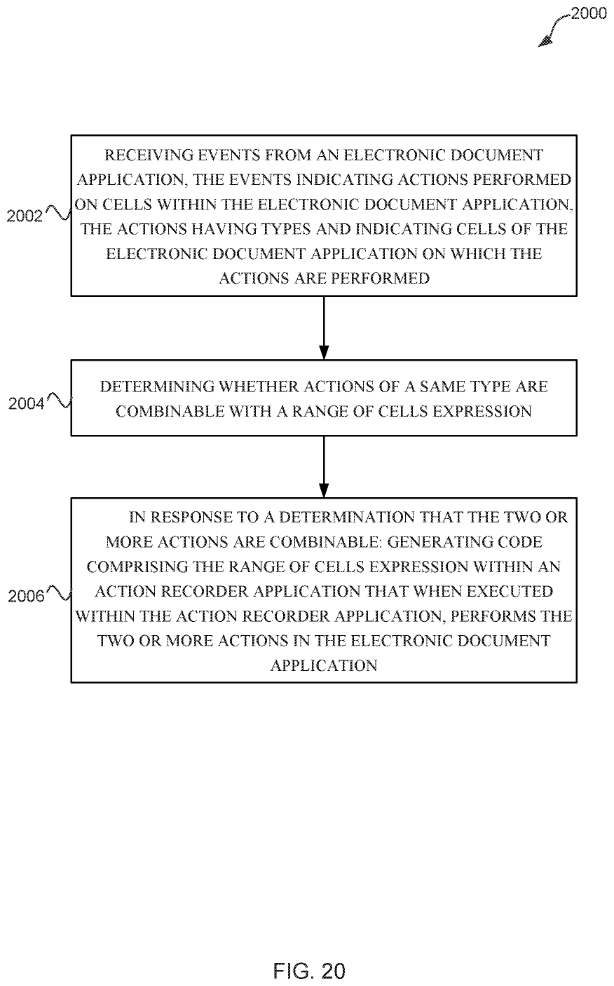

FIG. 20 illustrates a method 2000 of combining recorded actions, in accordance with some embodiments. The method 2000 begins at operation 2002 with receiving events from an electronic document application, the events indicating actions performed on cells within the electronic document application, the actions having types and indicating cells of the electronic document application on which the actions are performed.

For example, referring to FIG. 1, application 114 may receive event 108 from electronic document application where the event 108 indicates an operation 121. In another example, referring to FIG. 3, application 114 may receive events 108 with indications of actions within electronic document application 102, e.g., add sheet 310. In another example, referring to FIGS. 8, 9, and 10, application 102 may receive actions 802, 902, 1002, from electronic document application 102. In another example, referring to FIG. 2, method 200 may be performed by application 114 where at operation 206 an event that includes an operation 121 is received from electronic document application 102. In another example, method 1302 may have received actions 1402 from application 114.

Method 2000 continues at operation 2004 with determining whether actions of a same type are combinable with a range of cells expression. For example, method 1300 determines whether actions of a same type are combinable with a range of cells expression. In another example, combined ranges 1405, 1504, and 1604 may be the result of applying method 1300, 1700, 1800, or 2000. The methods 1700 and 1800 may be used to determined whether action of a same type are combinable with a range of cells expression. In another example, FIG. 19 illustrates cells 1906 where the combinability of actions with a same type are determined. In another example, combining 138 may determine whether operations 121 received from events 108 are combinable with a range 123.

Method 2000 continues at operation 2006 with in response to a determination that the two or more actions are combinable: generating code comprising the range of cells expression within an action recorder application that when executed within the action recorder application, performs the two or more actions in the electronic document application. In an example, generate code 130 or combining 138 may determine whether operations 121 received from events 108 are combinable with a range 123. FIG. 14 illustrates partial code generated at combined ranges 1405. FIG. 15 illustrates code with combined ranges 1504 with a line of code, e.g., 1512 and 1514. FIG. 16 illustrates code with combined ranges 1604 with a line of code, e.g., 1614, 1616, and 1618. In some embodiments, the code may be a single line of code.

Method 2000 may be performed on a computing device that includes a processor and memory comprising instructions which when performed by the processor, cause the processor to perform operations of method 2000. Method 2000 may include one or more additional operations. One or more of the operations of method 2000 may be optional. Method 2000 may be performed in a different order.

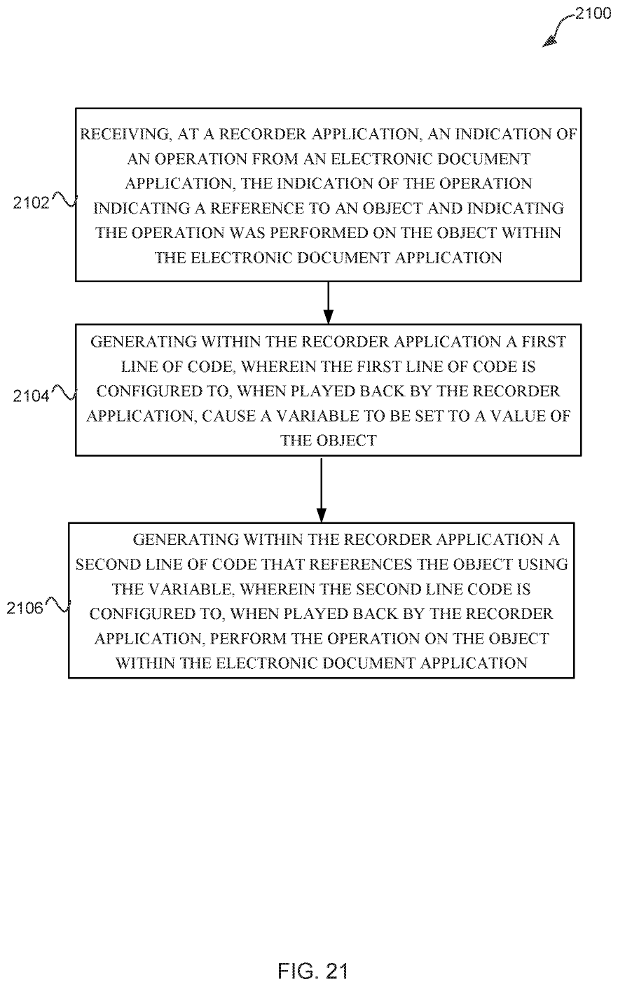

FIG. 21 illustrates a method 2100 for aliasing entities in recorded code, in accordance with some embodiments. The method 2100 begins at operation 2102 with receiving, at a recorder application, an indication of an operation from an electronic document application, the indication of the operation indicating a reference to an object and indicating the operation was performed on the object within the electronic document application. For example, referring to FIG. 1, application 114 may receive event 108 from electronic document application where the event 108 indicates an operation 121. In another example, referring to FIG. 3, application 114 may receive events 108 with indications of actions within electronic document application 102, e.g., add sheet 310. In another example, referring to FIGS. 8, 9, and 10, application 102 may receive actions 802, 902, 1002, from electronic document application 102. In another example, referring to FIG. 2, method 200 may be performed by application 114 where at operation 206 an event that includes an action is received from electronic document application 102.

The action may indicate a reference to an object within the electronic document application where the object has not been set to the variable within the action recorder application.

The method 2100 may continue at operation 2104 with generating within the recorder application a first line of code, wherein the first line of code is configured to, when played back by the recorder application, cause a variable to be set to a value of the object. The method 2100 may continue at operation 2106 with generating within the recorder application a second line of code that references the object using the variable, wherein the second line code is configured to, when played back by the recorder application, perform the operation on the object within the electronic document application.

In an example of operation 2102-2106, generate code 130 (FIG. 1) in response to event “edit cell” 318 where a value of “worksheetid: ‘id2’” is not set to an alias or second variable (e.g., “sheet_2”), generates code 512 (FIG. 5) with (second line of code) “let Sheet_2=“and (third line of code) “sheet_2.getRange . . . ”. In another example of operations 2102-2106, generate code 130 (FIG. 1) in response to action 908 where “sheetID: <ID1>” is not set to an alias or second variable (e.g., “sheet”), generates code 912 (second line of code) “let sheet= . . . ” and code 914 (third line of code) “ ”sheet.name . . . ”. In another example of operations 2102-2106, generate code 130 (FIG. 1) in response to action 1008 (FIG. 10) where a value of “sheetID: <id1>” is not set to an alias or second variable (e.g., “sheet”) generates code 1012 (second line of code) “let sheet . . . ” and code 1014 (third line of code) “Let range=sheet.getrange . . . ”.

Method 2100 may be performed on a computing device that includes a processor and memory comprising instructions which when performed by the processor, cause the processor to perform operations of method 2100. Method 2100 may include one or more additional operations. One or more of the operations of method 2100 maybe optional. Method 2100 maybe performed in a different order.

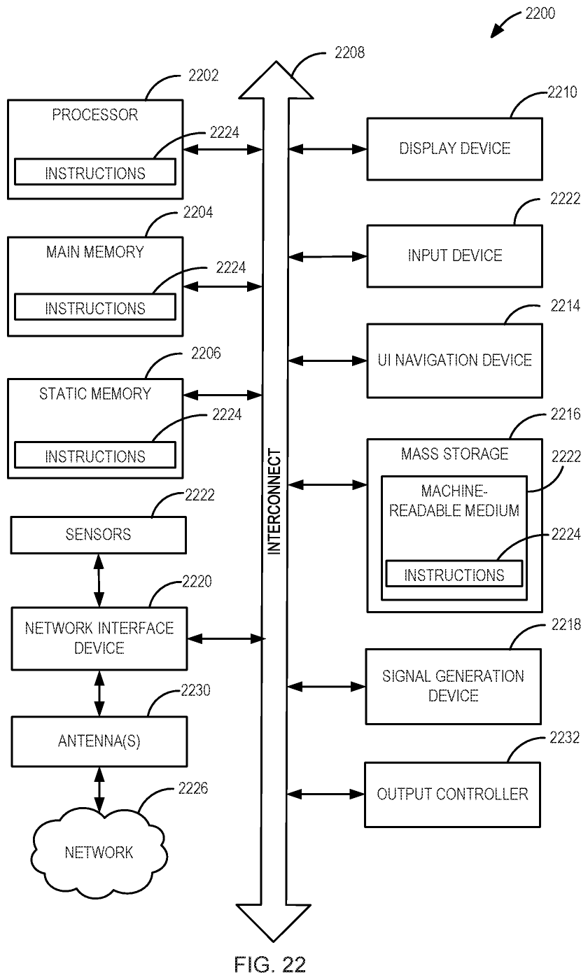

FIG. 22 illustrates a block diagram of an example machine 2200 upon which any one or more of the techniques (e.g., methodologies) discussed herein may perform. In alternative embodiments, the machine 2200 may operate as a standalone device or may be connected (e.g., networked) to other machines. In a networked deployment, the machine 2200 may operate in the capacity of a server machine, a client machine, or both in server-client network environments. In an example, the machine 2200 may act as a peer machine in peer-to-peer (P2P) (or other distributed) network environment. The machine 2200 may be a server, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 2200 may include a hardware processor 2202 (e.g., a central processing unit (CPU), a graphics processing unit (GPU), a hardware processor core, or any combination thereof), a main memory 2204 and a static memory 2206, some or all of which may communicate with each other via an interlink (e.g., bus) 2208.

Specific examples of main memory 2204 include Random Access Memory (RAM), and semiconductor memory devices, which may include, in some embodiments, storage locations in semiconductors such as registers. Specific examples of static memory 2206 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 2200 may further include a display device 2210, an input device 2212 (e.g., a keyboard), and a user interface (UI) navigation device 2214 (e.g., a mouse). In an example, the display device 2210, input device 2212 and UI navigation device 2214 may be a touch screen display. The machine 2200 may additionally include a mass storage (e.g., drive unit) 2216, a signal generation device 2218 (e.g., a speaker), a network interface device 2220, and one or more sensors 2221, such as a global positioning system (GPS) sensor, compass, accelerometer, or other sensor. The machine 2200 may include an output controller 2232, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.). In some embodiments the processor 2202 and/or instructions 2224 may comprise processing circuitry and/or transceiver circuitry.

The storage device 2216 may include a machine readable medium 2222 on which is stored one or more sets of data structures or instructions 2224 (e.g., software) embodying or utilized by any one or more of the techniques or functions described herein. For example, one or more of electronic document application 102, application 114, or macro recorder 116 may be implemented by machine 2200 to form a special purpose machine 2200. The instructions 2224 may also reside, completely or at least partially, within the main memory 2204, within static memory 2206, or within the hardware processor 2202 during execution thereof by the machine 2200. In an example, one or any combination of the hardware processor 2202, the main memory 2204, the static memory 2206, or the storage device 2216 may constitute machine-readable media. Example machine-readable medium may include non-transitory machine-readable medium that may include tangible non-transitory medium for storing information in a form readable by one or more computers, such as but not limited to read only memory (ROM); random access memory (RAM); magnetic disk storage media; optical storage media; a flash memory, etc.

Specific examples of machine-readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 2222 is illustrated as a single medium, the term “machine readable medium” may include a single medium or multiple media (e.g., a centralized or distributed database, and/or associated caches and servers) configured to store the one or more instructions 2224.

The instructions 2224 may further be transmitted or received over a communications network 2226 using a transmission medium via the network interface device 2220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, Licensed Assisted Access (LAA), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 2220 may include one or more physical jacks (e.g., Ethernet, coaxial, or phone jacks) or one or more antennas to connect to the communications network 2226. In an example, the network interface device 2220 may include one or more antennas 2230 to wirelessly communicate using at least one of single-input multiple-output (SIMO), multiple-input multiple-output (MIMO), or multiple-input single-output (MISO) techniques. In some examples, the network interface device 2220 may wirelessly communicate using Multiple User MIMO techniques. The term “transmission medium” shall be taken to include any intangible medium that is capable of storing, encoding or carrying instructions for execution by the machine 2200, and includes digital or analog communications signals or other intangible medium to facilitate communication of such software.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The following examples pertain to further embodiments. Example 1 is a computing device, the computing device including a processor; a memory, including instructions, which when performed by the processor, cause the processor to perform operations including: receiving events from an electronic document application, the events indicating actions performed on cells within the electronic document application, the actions having types and indicating cells of the electronic document application on which the actions are performed.

In some embodiments, the instructions further cause the processor to perform operations including: determining whether two or more of the actions having a same type are combinable with a range of cells expression; and in response to a determination that the two or more actions are combinable: generating code comprising the range of cells expression within an action recorder application that when executed within the action recorder application, performs the two or more actions in the electronic document application.

In Example 2, the subject matter of Example 1 can optionally include where the line of code uses an application program interface (API) of the electronic document application to perform the actions within the electronic document application.

In Example 3, the subject matter of Example 1 can optionally include where determining whether the two or more actions having the same type are combinable with the range of cells expression further includes determining whether the two or more actions having the same type are combinable with the range of cells expression by: determining whether a rectangle of cells encloses the cells of the electronic document application on which the actions are performed; and determining whether the rectangle of cells does not enclose more than a threshold of cells on which the actions are not performed.

In Example 4, the subject matter of Example 3 can optionally include where the electronic document application is a spreadsheet and the cells are part of a grid of a spreadsheet.

In Example 5, the subject matter of Example 1 can optionally include where the instructions further cause the processor to perform operations including grouping actions having the same type into a group; sorting the actions having the same type within the group; selecting a first sorted action of the sorted actions; stretching a one-by-one rectangle of a cell indicated by the first sorted action by one cell to a right direction, an up direction, or a down direction; determining whether the stretched one-by-one rectangle comprises less than a threshold of cells not indicated by the first sorted action or another action having the same type within the group; in response to a determination that the stretched one-by-one rectangle comprises less than the threshold of cells, determining to stretch the stretched one-by-one rectangle, and determining the range of cells expression to include the stretched one-by-one rectangle; and in response to a determination that the stretched one-by-one rectangle comprises more than the threshold of cells, determine not to stretch the stretched one-by-one rectangle.

In Example 6, the subject matter of Example 1 can optionally include where an action of the actions is one from the following group: bold, set color, cell value edits, and set background color.

In Example 7, the subject matter of Example 1 can optionally include where the instructions further cause the processor to perform operations including determining the two or more actions having the same type are not combinable with the range of cells expression if more than a threshold of actions of a different type are received between the two or more actions having the same type.

In Example 8, the subject matter of Example 1 can optionally include where determining whether two or more actions having the same type are combinable with the range of cells expression further includes: grouping actions based on the type into a plurality of groups; and determining whether two or more actions of a same group of the plurality of groups are combinable with the range of cells expression.

In Example 9, the subject matter of Example 1 can optionally include where the events are a sequence of actions performed in an order by a user, and wherein determining whether two or more actions of the same type are combinable with the range of cells expression further includes grouping together actions that are not interrupted in the sequence of actions by an interruption action, wherein the interruption action is one of the following group: creation of a chart, creation of a table, and creation of sheet; and determining whether two or more actions having the same type and of a same group are combinable with the range of cells expression.

In Example 10, the subject matter of Example 1 can optionally include where the range of cells expression comprises an expression that indicates a rectangle of cells of a spreadsheet.

In Example 11, the subject matter of Example 1 can optionally include where at least one cell indicated by the range of cells expression is not indicated by an action of the same type.

In Example 12, the subject matter of Example 11 can optionally include where the line of code indicates a null value for the at least one cell not indicated by the action of the same type.

In Example 13, the subject matter of Example 1 can optionally include where the instructions further cause the processor to perform operations includes in response to a determination that the two or more actions having the same type are not combinable with the range of cells expression, generating a separate line of code for each of the two or more actions.

In Example 14, the subject matter of Example 1 can optionally include where the instructions further cause the processor to perform operations including: in response to a determination that the two or more actions are combinable with the range of cells expression, determining whether an additional two or more actions having an additional same type are combinable with an additional range of cells expression; and in response to a determination that the additional two or more actions are combinable with the additional range of cells expression, generating an additional line of code within the action recorder application that when executed within the action recorder application performs within the electronic document application the additional two or more actions having the additional same type that are combinable, the additional line of code comprising the additional range of cells expression.

In Example 15, the subject matter of Example 1 can optionally include where determining whether two or more actions having the same type are combinable with the range of cells expression further includes grouping actions based on the type into a plurality of groups; and for each group of the plurality of groups, determining one or more range of cells expressions that includes each action in each group, and for each of the one or more range of cells expressions generating a line of code within the action recorder application that when executed within the action recorder application performs within the electronic document application actions that are included in a corresponding range of cells expression of the one or more range of cells expressions, the line of code comprising the corresponding range of cells expression.

Example 16 is a method performed on a computing device, the method including receiving events from an electronic document application, the events indicating actions performed on cells within the electronic document application, the actions having types and indicating cells of the electronic document application on which the actions are performed; determining whether two or more of the actions having a same type are combinable with a range of cells expression; and in response to a determination that the two or more actions are combinable with the range of cells expression, generating a line of code within an action recorder application that when executed within the action recorder application performs within the electronic document application the two or more actions having the same type that are combinable, the line of code comprising the range of cells expression.

In Example 17, the subject matter of Example 16 can optionally include where the line of code uses an application program interface (API) of the electronic document application to perform the actions within the electronic document application.

Example 18 is a computer-readable storage medium that stores instructions for execution by one or more processors of a computing device, the instructions to configure the one or more processors to: receive events from a spreadsheet, the events indicating operations performed on cells of the spreadsheet, the operations having types; determine whether cells that are operated on by operations of a same type are combinable into a range of cells; and in response to a determination that the cells operated on by operations of the same type are combinable into the range of cells, generate macrocode to combine the operations of the same type that reference cells within the range of the cells into a single operation that indicates the range of cells is to be operated on by the single operation.

In Example 19, the subject matter of Example 18 can optionally include where an operation of the operations is one from the following group: bold, set color, cell value edits, and set background color.

In Example 20, the subject matter of Example 1 can optionally include where the instructions further configure the one or more processors to: in response to a first cell operated on by a first operation of a first type and a second cell operated on by a second operation of the first type being adjacent, combine the first cell and the second sell into the range of cells, wherein the first operation and the second operation are each one of the operations of the same type.

Example 21 is a computing device, the computing device including a processor; a memory, including instructions, which when performed by the processor, cause the processor to perform operations comprising: receiving an action from an electronic document application, the action indicating the action was performed within the electronic document application and the action indicating a reference to an object within the electronic document application; generating a first line of code that when executed within an action recorder application sets a variable to a value of the object; and generating a second line of code that references the object using the variable and that when executed within the action recorder application performs the action within the electronic document application.

In Example 22, the subject matter of Example 21 can optionally include where receiving the action further comprises wherein the value of the object is not set to the variable within the action recorder application.

In Example 23, the subject matter of Example 21 can optionally include where the instructions further cause the processor to perform operations comprising: receiving a second action, the second action indicating generation of a second object within the electronic document application; generating a third line of code that when executed within the action recorder application generates the second object within the electronic document application and sets a second variable to a second value of the second object within the action recorder application.

In Example 24, the subject matter of Example 21 can optionally include where the instructions further cause the processor to perform operations comprising: receiving a second action, the second action indicating the reference to the object within the electronic document application where the value of the object is set to the variable within the action recorder application; generating a third line of code that when executed within the action recorder application performs the second action within the electronic document application, wherein the object is referenced using the variable in the third line of code.

In Example 25, the subject matter of Example 21 can optionally include where the action is a user interface action of the electronic document application, and wherein receiving an action from an electronic document application further includes receiving an event, the event comprising the action.

In Example 26, the subject matter of Example 21 can optionally include where the instructions further cause the processor to perform operations including generating a globally unique identifier or a universally unique identifier; and assigning the globally unique identifier or the universally unique identifier to the name of the variable.

In Example 27, the subject matter of Example 21 can optionally include where the instructions further cause the processor to perform operations including generating a node of a code tree for the action, wherein a code portion is associated with the node, and wherein the code portion comprises a placeholder for the variable; and processing the code tree into the code, wherein the placeholder is replaced with the name of the variable.

In Example 28, the subject matter of Example 21 can optionally include where the processing the code is performed by traversing the code tree inorder. In Example 29, the subject matter of Example 21 can optionally include where the object is one of the following group: a table, a sheet, and a chart.

In Example 30, the subject matter of Example 21 can optionally include where the action indicates activation or selection of the object within the electronic document application, and the instructions further cause the processor to perform operations including generating the first line of code and the second line of code to refrain from including code that recites activating or selecting the object.

In Example 31, the subject matter of Example 21 can optionally include where the electronic document application is a spreadsheet application and wherein the instructions further cause the processor to perform operations including receiving an event indicating a start recorder event; fetching names of sheets, tables, and a selected sheet in a workbook of the spreadsheet application; and storing the names of the sheets, tables, and the selected sheet.

In Example 32, the subject matter of Example 31 can optionally include where the instructions further cause the processor to perform operations including: generating a name of the variable based on the names of the sheets, tables, and the selected sheet.

In Example 33, the subject matter of Example 21 can optionally include where the code is JavaScript. In Example 34, the subject matter of Example 21 can optionally include where the first line of code uses an application program interface (API) for the electronic document application to perform the first action within the electronic document application.

In Example 35, the subject matter of Example 21 can optionally include where the action is a first action of a sequence of actions. Example 36 is a computer-readable storage medium that stores instructions for execution by one or more processors of a computing device, the instructions to configure the one or more processors to: receive an action from an electronic document application, the action indicating the action was performed within the electronic document application and the action indicating a reference to an object within the electronic document application; generate a first line of code that when executed within an action recorder application sets a variable to a value of the object; and generate a second line of code that references the object using the variable and that when executed within the action recorder application performs the action within the electronic document application.

In Example 37, the subject matter of Example 36 can optionally include where receiving the action further comprises wherein the value of the object is not set to the variable within the action recorder application.

Example 38 is a computer-implemented method including receiving an action from an electronic document application, the action indicating the action was performed within the electronic document application and the action indicating a reference to an object within the electronic document application; generating a first line of code that when executed within an action recorder application sets a variable to a value of the object; and generating a second line of code that references the object using the variable and that when executed within the action recorder application performs the action within the electronic document application.

In Example 39, the subject matter of Example 37 can optionally include where receiving the action further comprises wherein the value of the object is not set to the variable within the action recorder application.

In Example 40, the subject matter of Example 36 can optionally include where the computer-implemented method further comprises: receiving a second action, the second action indicating generation of a second object within the electronic document application; and generating a third line of code that when executed within the action recorder application generates the second object within the electronic document application and sets a second variable to a second value of the second object within the action recorder application.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

What is claimed is:

1. A computing device, the computing device comprising:
a processor;
a memory, comprising instructions, which when performed by the processor, cause the processor to perform operations comprising:
receiving, at a recorder application, an indication of an operation from an electronic document application, the indication of the operation indicating a reference to an object and indicating the operation was performed on the object within the electronic document application;
generating within the recorder application a first line of code, wherein the first line of code is configured to, when played back by the recorder application, cause a variable to be set to a value of the object; and
generating within the recorder application a second line of code that references the object using the variable, wherein the second line code is configured to, when played back by the recorder application, perform the operation on the object within the electronic document application.

2. The computing device of claim 1, wherein the instructions further cause the processor to perform operations comprising:
receiving a second indication of a second operation from the electronic document application, the second indication of the second operation indicating the second operation was performed within the electronic document application and the second operation indicating generation of a second object within the electronic document application; and
generating within the recorder application a third line of code, wherein the third line code is configured to, when played back by the recorder application, causes the second object to be generated within the electronic document application and a second variable to be set to a value of the second object within the recorder application.

3. The computing device of claim 1, wherein the instructions further cause the processor to perform operations comprising:
receiving a second indication of a second operation from the electronic document application, the second indication of the second operation indicating the second operation was performed within the electronic document application and the second operation indicating the reference to the object within the electronic document application, where the variable is set to the value to the object;
generating within the recorder application a third line of code that references the object using the variable, wherein the third line of code is configured to, when played back by the recorder application, cause the second operation to be performed within the electronic document application.

4. The computing device of claim 1, wherein the operation is a user interface operation of the electronic document application, and wherein receiving an operation from an electronic document application further comprises:
receiving an event, the event comprising the operation.

5. The computer device of claim 1, wherein the instructions further cause the processor to perform operations comprising:
generating a globally unique identifier or a universally unique identifier; and
assigning the globally unique identifier or the universally unique identifier to the name of the variable.

6. The computer device of claim 1, wherein the instructions further cause the processor to perform operations comprising:
generating a node of a code tree for the operation, wherein a code portion is associated with the node, and wherein the code portion comprises a placeholder for the variable; and
processing the code tree into the code, wherein the placeholder is replaced with the name of the variable.

7. The computer device of claim 6, wherein the processing the code is performed by traversing the code tree inorder.

8. The computer device of claim 1, wherein the object is one of the following group: a table, a sheet, and a chart.

9. The computer device of claim 1, wherein the operation indicates activation or selection of the object within the electronic document application, and the instructions further cause the processor to perform operations comprising:
generating the first line of code and the second line of code to refrain from including code that recites activating or selecting the object.

10. The computer device of claim 1, wherein the electronic document application is a spreadsheet application and wherein the instructions further cause the processor to perform operations comprising:
receiving an event indicating a start recorder event;
fetching names of sheets, tables, and a selected sheet in a workbook of the spreadsheet application; and
storing the names of the sheets, tables, and the selected sheet.

11. The computer device of claim 10, wherein the instructions further cause the processor to perform operations comprising:
generating a name of the variable based on the names of the sheets, tables, and the selected sheet.

12. The computer device of claim 1, wherein the code is JavaScript.

13. The computing device of claim 1, wherein the second line of code uses an application program interface (API) to perform the operation on the object within the electronic document application.

14. The computer device of claim 1, wherein the operation is a first operation of a sequence of operations.

15. A computer-readable storage medium that stores instructions for execution by one or more processors of a computing device, the instructions to configure the one or more processors to:
receive, at a recorder application, an indication of an operation from an electronic document application, the indication of the operation indicating a reference to an object and indicating the operation was performed on the object within the electronic document application;
generate within the recorder application a first line of code, wherein the first line of code is configured to, when played back by the recorder application, causes a variable to be set to a value of the object; and
generate within the recorder application a second line of code that references the object using the variable, wherein the second line code is configured to, when played back by the recorder application, perform the operation on the object within the electronic document application.

16. The computer-readable storage medium of claim 15, wherein the instructions further configure the one or more processors to:
receiving, at a recorder application, an indication of an operation from an electronic document application, the indication of the operation indicating a reference to an object and indicating the operation was performed on the object within the electronic document application;
generating within the recorder application a first line of code, wherein the first line of code is configured to, when played back by the recorder application, causes a variable to be set to a value of the object; and
generating within the recorder application a second line of code that references the object using the variable, wherein the second line code is configured to, when played back by the recorder application, perform the operation on the object within the electronic document application.

17. The computer-readable storage medium of claim 15, wherein the instructions further configure the one or more processors to:
receive a second indication of a second operation from the electronic document application, the second indication of the second operation indicating the second operation was performed within the electronic document application and the second operation indicating the reference to the object within the electronic document application, where the variable is set to the value to the object;
generate within the recorder application a third line of code that references the object using the variable, wherein the third line of code is configured to, when played back by the recorder application, cause the second operation to be performed within the electronic document application.

18. A computer-implemented method comprising:
receiving, at a recorder application, an indication of an operation from an electronic document application, the indication of the operation indicating a reference to an object and indicating the operation was performed on the object within the electronic document application;
generating within the recorder application a first line of code, wherein the first line of code is configured to, when played back by the recorder application, causes a variable to be set to a value of the object; and
generating within the recorder application a second line of code that references the object using the variable, wherein the second line code is configured to, when played back by the recorder application, perform the operation on the object within the electronic document application.

19. A computer-implemented method of claim 18, wherein the computer-implemented method further comprises:
receiving a second indication of a second operation from the electronic document application, the second indication of the second operation indicating the second operation was performed within the electronic document application and the second operation indicating generation of a second object within the electronic document application; and
generating within the recorder application a third line of code, wherein the third line code is configured to, when played back by the recorder application, causes the second object to be generated within the electronic document application and a second variable to be set to a value of the second object within the recorder application.

20. A computer-implemented method of claim 18, wherein the computer-implemented method further comprises:
receiving a second indication of a second operation from the electronic document application, the second indication of the second operation indicating the second operation was performed within the electronic document application and the second operation indicating the reference to the object within the electronic document application, where the variable is set to the value to the object;
generating within the recorder application a third line of code that references the object using the variable, wherein the third line of code is configured to, when played back by the recorder application, cause the second operation to be performed within the electronic document application.
